(19) United States
(12) Patent Application Publication
(10) Pub. No.: US 2001/0003834 A1
(43) Pub. Date: Jun. 14, 2001

(54) Interprocessor communication method and multiprocessor

(75) Inventor: Hideyuki Shimonishi, Tokyo (JP)

Correspondence Address: FOLEY & LARDNER, Washington Harbour, 3000 K Street N.W., Suite 500, P. O. Box 25696, Washington, DC, 20007-8696, US

(73) Assignee: NEC CORPORATION

(21) Appl. No.: 09/730,533

(22) Filed: Dec. 7, 2000

(30) Foreign Application Priority Data
Dec. 8, 1999 (JP) 11-348545

(51) Int. Cl. G06F 15/00; G06F 15/76

(52) U.S. Cl. 709/310; 712/33

(57) ABSTRACT

In a multiprocessor system including numbers of processors which realizes hierarchical interprocessor communication and enables high-speed interprocessor communication, each processing element is composed of a plurality of processors physically sharing the same register file, and in the processing element, interprocessor communication is conducted by sharing the register. Every several processing elements are connected to the same local bus and the local buses are connected to each other by a bridge and a global bus. Between processing elements located at a short distance from each other, communication is conducted through one local bus, while between processing elements located at a long distance from each other, communication is conducted through a plurality of local buses and global buses.

### BACKGROUND OF THE INVENTION

1. Field of the Invention

The present invention relates to an interprocessor communication method in a multiprocessor system and, more particularly, to a method of exchanging the contents of a register file in a processor between processors and a multiprocessor system having a hierarchical communication mechanism.

2. Description of the Related Art

As an interprocessor communication method in a multiprocessor system, the following methods have been conventionally proposed.

First conventional method is sharing a memory or a cache among processors. When data transmission and reception is required between processors, a processor on the transmission side writes transmission data into a shared cache or memory and a processor on the reception side reads the data from the cache or memory in question. For example, recited in Japanese Patent No. 2533162 is a method in which a memory shared by processors is provided and each processor and the memory are connected by a bus to conduct communication between register files each processor has through the shared memory. In a case, for example, where a primary cache is provided for each processor and a secondary cache is shared, a bus for connecting each primary cache and the shared second cache is provided to exchange data between the primary caches and the secondary cache using the bus. The literature, “B. A. Nayfeh et. al: Evaluation of Design Alternatives for a Multiprocessor, ISCA '96, pp. 67-71, 1996”, introduces models in which a primary cache is shared, in which a secondary cache is shared and in which a memory is shared.

Second conventional method is sharing a register file by all the processors. According to this method, not a register file prepared individually for each processor but a register file having a plurality of ports enabling all the processors to read and write simultaneously is provided and shared by all the processors. For example, Japanese Patent Laying-Open (Kokai) No. Heisei 10-78880 proposes an interprocessor communication method related to a multi-thread execution system, in which interprocessor communication realized by sharing a register file is also proposed.

Third conventional method is conducting communication between processors which is realized, with a register file provided individually for each processor, by copying the contents of the registers among the respective register files. Each register file has not only a port for enabling the corresponding processor to read and write but also a port for directly transmitting and receiving data to and from other register files, through which port the contents of each register are copied. Since a communication path for simultaneously transmitting and receiving the contents of a plurality of registers is provided between the register files, the contents of the plurality of registers can be copied simultaneously. For example, recited in Japanese Patent Laying-Open (Kokai) No. Heisei 10-78880 are a method of conducting multiple-communication between arbitrary register files, with each register file connected to a bus and a method of conducting communication only between adjacent register files, with the respective register files connected in a ring.

According to the first conventional method, for communicating data on a register file between processors, a transmission source processor should transfer data on a register file to a shared cache or memory and a reception side processor should transfer data on a cache or a memory to a register, so that a time required for interprocessor communication is liable to be increased. On the other hand, the second conventional method allows a register used by a transmission source processor to be referred to by other processor to enable interprocessor communication without physical data transfer and the third conventional method allows each register file to copy the contents of a register without the intervention of a cache or a memory, both of which methods enable a further reduction in a time required for interprocessor communication than by the first conventional method.

The second conventional method, however, has a problem that since a register file is shared by processors, as the number of processors is increased, it will be more difficult for an individual processor to access a register file at a high speed. This is because each register file needs as many ports for reading and writing as the number of processors and the increase in the number of ports results in decreasing an access operation speed.

Also with respect to the third conventional method, according to the method of connecting each register file by a bus, as the number of processors is increased, it will be more difficult to conduct highband communication between the register files. The reason is that since one bus is shared by a plurality of register files, as the number of register files is increased, the volume of communication per one register file is decreased and as the number of register files connected to a bus is increased, an operation speed of the bus is reduced to decrease a bus band.

Furthermore, according to the method of connecting the respective register files in a ring, since the register contents can be copied between only adjacent register files, when a processor as a transmission source communicates with other processor than its adjacent processor, communication should sequentially go through all the processors located therebetween, so that when communication between arbitrary processors is necessary, high-speed interprocessor communication will be difficult.

### SUMMARY OF THE INVENTION

An object of the present invention, taking the foregoing problems into consideration, is to realize high-speed interprocessor communication even at a multiprocessor system including numbers of processors.

According to one aspect of the invention, an interprocessor communication method of exchanging the contents of register files among processors constituting a multiprocessor system, comprising the steps of

dividing a group of processors constituting the multiprocessor system into a plurality of groups of processing elements,

conducting interprocessor communication by physically sharing the same register file among processors belonging to the same processing element, and

conducting interprocessor communication by directly transferring the contents of a register file through a bus between processors belonging to different processing elements.

According to the method of the present invention, physically sharing a register file by several processors between which processors communication is frequently conducted enables high-speed interprocessor communication between such processors, and even between processors which fail to physically share a register file, interprocessor communication is realized by direct transfer of a register file through a bus.

Use, as a bus for connecting processing elements, of a bus having a channel one-to-one corresponding to each register included in the register file realizes high-band communication. In addition, using a bus having a channel whose number is smaller than the number of registers included in the register file to make a plurality of registers share one channel reduces a required volume of hardware although a bus band is reduced accordingly.

In the preferred construction, a bus is used which has a channel one-to-one corresponding to each register included in the register file.

In another preferred construction, a bus having a channel whose number is smaller than the number of registers included in the register file is used to enable a plurality of registers to share one channel.

In another preferred construction, a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and

not less than one route which connects the processing elements by a bus and causes no bus contention with other routes is determined in advance to conduct only interprocessor communication using the determined route.

In another preferred construction, a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and

not less than one route which connects the processing elements by a bus and causes no bus contention with other routes is determined in advance to conduct only interprocessor communication using the determined route.

In another preferred construction, a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and

not less than one route which connects the processing elements by a bus and causes no time contention on the same bus with other routes and a time of use of each bus by each route are determined in advance to time-divisionally use the buses, thereby conducting only interprocessor communication using the determined route and time of use.

In another preferred construction, a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and

not less than one route which connects the processing elements by a bus and causes no time contention on the same bus with other routes and a time of use of each bus by each route are determined in advance to time-divisionally use the buses, thereby conducting only interprocessor communication using the determined route and time of use.

In another preferred construction, the processors are operated in synchronization with time and each processor is programmed to execute only the interprocessor communication by the determined route and time of use, and each bridge conducts data relay operation only in the interprocessor communication by the determined route and time of use, thereby time-divisionally using the buses.

In another preferred construction, a transmission control unit for controlling transmission of the contents of the register file in the processing element through the bus according to a transmission request from the processor belonging to the processing element in question provides control such that only interprocessor communication by the determined route and time of use is conducted and each bridge executes data relay operation only in interprocessor communication by the determined route and time of use, thereby time-divisionally using the buses.

In another preferred construction, a time table for conducting input/output control by time is provided in the processing element and a time table for conducting relay control by time is provided in the bridge, and input/output control at the processing element and path control at the bridge are determined uniquely with respect to time by using these time tables, and

when a transmission request is made from the processor, a transmission control unit in the processing element refers to the time table based on time to conduct output control of data from the register to the bus, the bridge refers to the time table based on time to conduct relay processing of data between the buses and a reception control unit in the processing element refers to the time table based on time to conduct input control of data from the bus to the register, thereby

time-divisionally using the buses.

In another preferred construction, a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data destination as control information is provided in the bus, and

at the time of outputting data from the processor, a transmission request is made with the connection number or the destination as control information, a transmission control unit in the processing element refers to the connection table and the time table based on the control information to conduct output control of data and control information to the buses, the bridge refers to the connection table based on the control information received from the control channel to conduct relay processing of data and control information between the buses and a reception control unit in the processing element refers to the connection table based on the received control information to conduct input control of data from the bus to the register, thereby

time-divisionally using the buses.

In another preferred construction, a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and

not less than one route which connects the processing elements by a bus and causes no contention on the same channel of the same bus with other routes is determined in advance to space-divisionally use the buses on a channel basis, thereby conducting only interprocessor communication using the determined route.

In another preferred construction, a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and

not less than one route which connects the processing elements by a bus and causes no contention on the same channel of the same bus with other routes is determined in advance to space-divisionally use the buses on a channel basis, thereby conducting only interprocessor communication using the determined route.

In another preferred construction, each processor is programmed to execute only the interprocessor communication by the determined route, and each bridge conducts data relay operation only in the interprocessor communication by the determined route, thereby

space-divisionally using the buses. In another preferred construction, a transmission control unit for controlling transmission of the contents of the register file in the processing element through the bus according to a transmission request from the processor belonging to the processing element in question provides control such that only interprocessor communication by the determined route is conducted and each bridge executes data relay operation only in interprocessor communication by the determined route, thereby

space-divisionally using the buses.

In another preferred construction, a connection table for conducting input/output control is provided for each channel in the processing element and a connection table for conducting relay control is provided for each channel in the bridge, and input/output control at the processing element and path control at the bridge are determined for each channel by using these connection tables, and

at the time of outputting data from the processor, not less than one register is selected to make a transmission request, a transmission control unit in the processing element refers to the connection table related to a channel corresponding to each register to which the transmission request is made to conduct output control of data from each register to the bus on a channel basis, the bridge refers to the connection table related to each channel to conduct relay processing of data between the buses for each channel and a reception control unit in the processing element refers to the connection table related to each channel to conduct input control of data from the bus to the register for each channel, thereby

space-divisionally using the buses.

In another preferred construction, a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and

not less than one route which connects the processing elements by a bus and causes no time contention on the same channel of the same bus with other routes and a time of use of a channel of each bus by each route are determined in advance to time-divisionally and space-divisionally use the buses on a channel basis, thereby conducting only interprocessor communication using the determined route and time of use.

In another preferred construction, a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and

not less than one route which connects the processing elements by a bus and causes no time contention on the same channel of the same bus with other routes and a time of use of a channel of each bus by each route are determined in advance to time-divisionally and space-divisionally use the buses on a channel basis, thereby conducting only interprocessor communication using the determined route and time of use.

In another preferred construction, the processors are operated in synchronization with time and each processor is programmed to execute only the interprocessor communication by the determined route and time of use, and each bridge conducts data relay operation only in the interprocessor communication by the determined route and time of use, thereby

time-divisionally and space-divisionally using the buses.

In another preferred construction, a transmission control unit for controlling transmission of the contents of the register file in the processing element through the bus according to a transmission request from the processor belonging to the processing element in question provides control such that only interprocessor communication by the determined route and time of use is conducted and each bridge executes data relay operation only in interprocessor communication by the determined route and time of use, thereby

time-divisionally and space-divisionally using the buses.

In another preferred construction, a time table for conducting input/output control by time is provided for each channel in the processing element and a time table for conducting relay control by time is provided for each channel in the bridge, and input/output control at the processing element and path control at the bridge are determined for each channel uniquely with respect to time by using these time tables, and

when a transmission request is made from the processor, a transmission control unit in the processing element refers to each time table based on time to conduct output control of data from the register to the bus on a channel basis, the bridge refers to each time table based on time to conduct relay processing of data between the buses on a channel basis and a reception control unit in the processing element refers to each time table based on time to conduct input control of data from the bus to the register on a channel basis, thereby

time-divisionally and space-divisionally using the buses.

In another preferred construction, a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data designation as control information is provided for each channel in the bus, and

at the time of outputting data from the processor, a transmission request is made with the connection number or the destination as control information, a transmission control unit in the processing element refers to each connection table and each time table based on control information to conduct output control of data and control information to the buses on a channel basis, the bridge refers to each connection table based on the control information received from the control channel to conduct relay processing of data and control information between the buses on a channel basis and a reception control unit in the processing element refers to each connection table based on the received control information to conduct input control of data from the bus to the register on a channel basis, thereby

time-divisionally and space-divisionally using the buses.

In another preferred construction, a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data designation as control information is provided for each channel in the bus, and

at the time of outputting data from the processor, a transmission request is made with the connection number or the destination as control information, a transmission control unit in the processing element refers to the connection table and the time table based on control information to conduct output control of data and control information to the buses on a channel basis, the bridge refers to each connection table based on the control information received from the control channel to conduct relay processing of data and control information between the buses on a channel basis and a reception control unit in the processing element refers to the connection table based on the received control information to conduct input control of data from the bus to the register on a channel basis, thereby

time-divisionally and space-divisionally using the buses.

In another preferred construction, the transmission control unit in each processing element, after a transmission request is made, inhibits write from the processor into a register relevant to the transmission request until data is actually output onto the bus.

In another preferred construction, the contents of a register file scheduled to be received are inhibited from being read and at a time when the reception control unit inputs the data received through the bus into the register file in the processing element, are changed to be readable.

According to another aspect of the invention, a multiprocessor system comprises

a plurality of processing elements including a plurality of processors physically sharing the same register file, and

a bus structure formed of a local bus for connecting register files of several adjacent processing elements with each other, not less than one global bus for connecting the local buses and not less than one bridge for relaying data between the buses.

In the preferred construction, each the bus has a channel one-to-one corresponding to each register included in the register file,

the register file of each processing element includes a time table for conducting input/output control by time, a transmission control unit for, when a transmission request is made from the processor, referring to the time table based on time to control output of data from the register to the bus and a reception control unit for referring to the time table based on time to control input of data from the bus to the register, and

each bridge includes a time table for conducting relay control by time and a relay circuit for referring to the time table based on time to conduct relay processing of data between the buses, thereby

forming a structure time-divisionally using buses.

In another preferred construction, each the bus has a channel whose number is smaller than the number of the registers included in the register file,

the register file of each processing element includes a time table for conducting input/output control by time, a transmission control unit for, when a transmission request is made from the processor, referring to the time table based on time to control output of data from the register to the bus and a reception control unit for referring to the time table based on time to control input of data from the bus to the register, and

each bridge includes a time table for conducting relay control by time and a relay circuit for referring to the time table based on time to conduct relay processing of data between the buses, thereby

forming a structure time-divisionally using buses.

In another preferred construction, each the bus has a channel one-to-one corresponding to each register included in the register file,

each bus includes a control channel for transmitting a connection number or a destination of data as control information,

the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses, and a reception control unit for referring to the connection table based on control information received from the bus to control input of data from the bus to the register, and

each bridge includes a connection table for conducting relay control by the connection number or the data destination, and a relay control unit and a relay circuit for referring to the connection table based on control information received from the control channel to conduct relay processing of data and control information between the buses, thereby

forming a structure time-divisionally using buses.

In another preferred construction, each the bus has a channel whose number is smaller than the number of the registers included in the register file,

each bus includes a control channel for transmitting a connection number or a destination of data as control information,

the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses, and a reception control unit for referring to the connection table based on control information received from the bus to control input of data from the bus to the register, and

each bridge includes a connection table for conducting relay control by the connection number or the data destination, and a relay control unit and a relay circuit for referring to the connection table based on control information received from the control channel to conduct relay processing of data and control information between the buses, thereby

forming a structure time-divisionally using buses.

In another preferred construction, each the bus has a channel one-to-one corresponding to each register included in the register file, and

the register file of each processing element includes a connection table for each channel for conducting input/output control, a transmission control unit for, when a transmission request designating a register which conducts transmission is made from the processor, referring to the connection table related to a channel corresponding to each register to which the transmission request is made to control output of data from each register to the bus on a channel basis, and a reception control unit for referring to the connection table related to each channel to control input of data from the bus to the register on a channel basis, and

each bridge includes a connection table for each channel for conducting relay control and a relay circuit for referring to the connection table related to each channel to conduct relay processing of data between the buses, thereby

forming a structure space-divisionally using buses.

In another preferred construction, each the bus has a channel whose number is smaller than the number of the registers included in the register file, and

the register file of each processing element includes a connection table for each channel for conducting input/output control, a transmission control unit for, when a transmission request designating a register which conducts transmission is made from the processor, referring to the connection table related to a channel corresponding to each register to which the transmission request is made to control output of data from each register to the bus on a channel basis, and a reception control unit for referring to the connection table related to each channel to control input of data from the bus to the register on a channel basis, and

each bridge includes a connection table for each channel for conducting relay control and a relay circuit for referring to the connection table related to each channel to conduct relay processing of data between the buses, thereby

forming a structure space-divisionally using buses.

In another preferred construction, each the bus has a channel one-to-one corresponding to each register included in the register file,

the register file of each processing element includes a time table for each channel for conducting input/output control by time, a transmission control unit for, when a transmission request is made from the processor, referring to each time table based on time to control output of data from the register to the bus on a channel basis, and a reception control unit for referring to each time table based on time to control input of data from the bus to the register on a channel basis, and

each bridge includes a time table for each channel for conducting relay control by time and a relay circuit for referring to each time table based on time to conduct relay processing of data between the buses on a channel basis, thereby

forming a structure time-divisionally and space-divisionally using buses.

In another preferred construction, each the bus has a channel whose number is smaller than the number of the registers included in the register file,

the register file of each processing element includes a time table for each channel for conducting input/output control by time, a transmission control unit for, when a transmission request is made from the processor, referring to each time table based on time to control output of data from the register to the bus on a channel basis and a reception control unit for referring to each time table based on time to control input of data from the bus to the register on a channel basis, and

each bridge includes a time table for each channel for conducting relay control by time and a relay circuit for referring to each time table based on time to conduct relay processing of data between the buses on a channel basis, thereby

forming a structure time-divisionally and space-divisionally using buses.

In another preferred construction, each the bus has a channel one-to-one corresponding to each register included in the register file,

each bus includes a control channel for each channel for transmitting a connection number or a destination of data as control information,

the register file of each processing element includes a connection table for each channel for conducting input/output control by the connection number or the destination of data and a time table for each channel for conducting input/output control by time, a transmission control unit for, when a transmission request with the connection number or the destination as control information is made from the processor, referring to each connection table and each time table based on the control information to control output of the data and the control information to the bus on a channel basis, and a reception control unit for referring to each connection table based on control information received from the bus to control input of data from the bus to the register on a channel basis, and

each bridge includes a connection table for each channel for conducting relay control by the connection number or the data destination, and a relay control unit and a relay circuit for referring to each connection table based on control information received from the control channel to conduct relay processing of data and the control information between the buses on a channel basis, thereby

forming a structure time-divisionally and space-divisionally using buses.

In another preferred construction, each the bus has a channel whose number is smaller than the number of the registers included in the register file,

each bus includes a control channel for each channel for transmitting a connection number or a destination of data as control information,

the register file of each processing element includes a connection table for each channel for conducting input/output control by the connection number or the destination of data and a time table for each channel for conducting input/output control by time, a transmission control unit, for when a transmission request with the connection number or the destination as control information is made from the processor, referring to each connection table and each time table based on the control information to control output of the data and the control information to the bus on a channel basis, and a reception control unit for referring to each connection table based on control information received from the bus to control input of data from the bus to the register on a channel basis, and

each bridge includes a connection table for each channel for conducting relay control by the connection number or the data destination, and a relay control unit and a relay circuit for referring to each connection table based on control information received from the control channel to conduct relay processing of data and the control information between the buses on a channel basis, thereby

forming a structure time-divisionally and space-divisionally using buses.

In another preferred construction, each the bus has a channel one-to-one corresponding to each register included in the register file,

each bus includes a control channel for each channel for transmitting a connection number or a destination of data as control information,

the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses on a channel basis, and a reception control unit for referring to the connection table based on control information received from the bus to control input of data from the bus to the register on a channel basis, and

each bridge includes a connection table for each channel for conducting relay control by the connection number or the data destination, and a relay control unit and a relay circuit for referring to each connection table based on control information received from the control channel to conduct relay processing of the data and the control information between the buses on a channel basis, thereby

forming a structure time-divisionally and space-divisionally using buses.

In another preferred construction, each the bus has a channel whose number is smaller than the number of the registers included in the register file,

each bus includes a control channel for each channel for transmitting a connection number or a destination of data as control information,

the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses on a channel basis, and a reception control unit for referring to the connection table based on control information received from the bus to control input of data from the bus to the register on a channel basis, and

each bridge includes a connection table for each channel for conducting relay control by the connection number or the data destination, and a relay control unit and a relay circuit for referring to each connection table based on control information received from the control channel to conduct relay processing of the data and the control information between the buses on a channel basis, thereby

forming a structure time-divisionally and space-divisionally using buses.

In another preferred construction, the transmission control unit in each processing element has a structure of inhibiting, after a transmission request is made, write from a processor into a register relevant to the transmission request until data is actually output onto the bus.

In another preferred construction, the transmission control unit in each processing element has a structure of inhibiting, after a transmission request is made, write from the processor into a register relevant to the transmission request until data is actually output onto the bus.

In another preferred construction, the multiprocessor includes

a structure of inhibiting read of the contents of a register file scheduled to be received and changing the contents to be readable at a time when the reception control unit inputs the data received through the bus into the register file in the processing element.

In another preferred construction, the multiprocessor includes

a structure of inhibiting read of the contents of a register file scheduled to be received and changing the contents to be readable at a time when the reception control unit inputs the data received through the bus into the register file in the processing element.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure of a first embodiment of a multiprocessor system to which the present invention is applied;

FIG. 2 is a diagram showing a structure of a processing element according to the first embodiment;

FIG. 3 is a diagram showing a structure of a bridge according to the first embodiment;

FIG. 4 is a diagram showing a structure of a connection table in the processing element according to the first embodiment;

FIG. 5 is a diagram showing a structure of a connection table in the bridge according to the first embodiment;

FIG. 6 is a diagram showing a structure of a processing element according to a second embodiment;

FIG. 7 is a diagram showing a structure of a bridge according to the second embodiment;

FIG. 8 is a diagram showing a structure of a time table in the processing element according to the second embodiment;

FIG. 9 is a diagram showing a structure of a time table in the bridge according to the second embodiment;

FIG. 10 is a diagram showing a structure of a processing element according to a third embodiment;

FIG. 11 is a diagram showing a structure of a bridge according to the third embodiment;

FIG. 12 is a diagram showing a structure of a connection table in the processing element according to the third embodiment;

FIG. 13 is a diagram showing a structure of a time table in the processing element according to the third embodiment;

FIG. 14 is a diagram showing a structure of a connection table in the bridge according to the third embodiment;

FIG. 15 is a diagram for use in explaining a reason a connection number is replaced in the bridge in the third embodiment;

FIG. 16 is a diagram showing a structure of a processing element according to a fourth embodiment;

FIG. 17 is a diagram showing a structure of a bridge according to the fourth embodiment;

FIG. 18 is a diagram showing one example of XY-coordinate values assigned to each processing element in a fifth embodiment;

FIG. 19 is a diagram showing a structure of a processing element according to the fifth embodiment;

FIG. 20 is a diagram showing a structure of a bridge according to the fifth embodiment;

FIG. 21 is a diagram showing an example of contents of a connection table provided in each bridge according to the fifth embodiment;

FIG. 22 is a diagram showing other example of a structure of a processing element;

FIG. 23 is a block diagram showing a structure of other embodiment of a multiprocessor system to which the present invention is applied;

FIG. 24 is a block diagram showing an example of a structure of a processor in each processing element.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

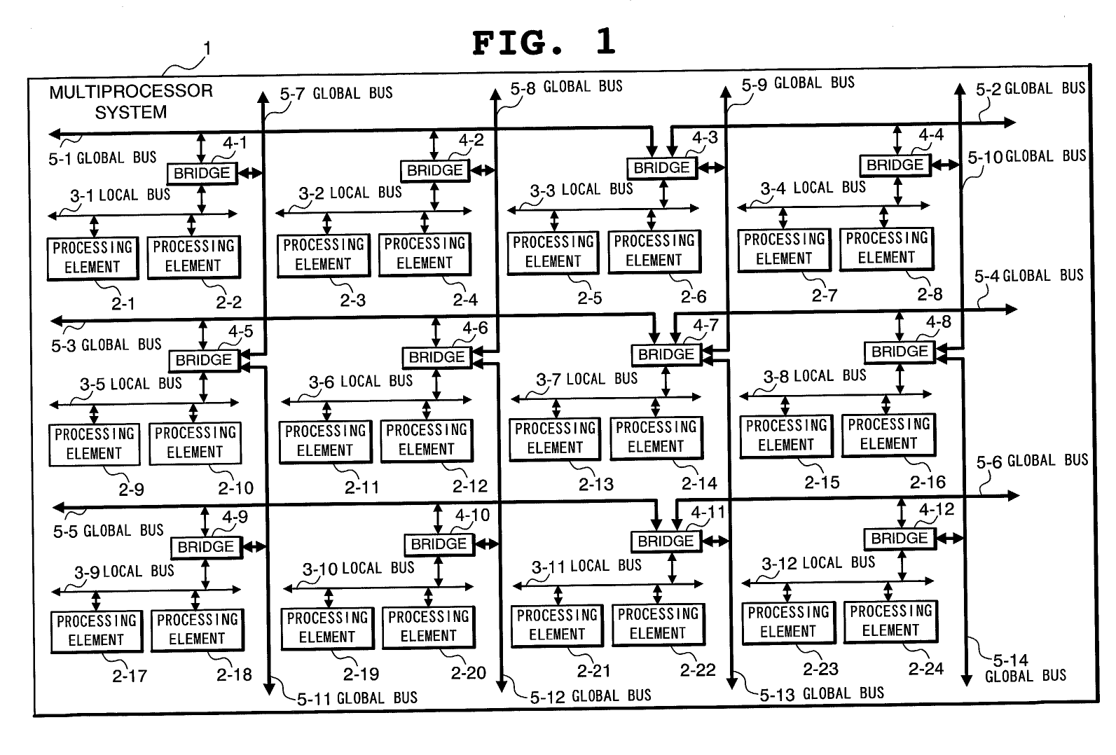

FIG. 1 is a block diagram showing a structure of a first embodiment of a multiprocessor system to which the present invention is applied. The multiprocessor system 1 according to the present embodiment includes a plurality of processing elements 2-1 to 2-24 including one register file and a plurality of processors sharing the file, local buses 3-1 to 3-12 for the communication between adjacent processing elements, global buses 5-1 to 5-14 for conducting communication between distant processing elements, and bridges 4-1 to 4-12 for connecting global buses and connecting a local bus and a global bus. In the following, when the local buses and global buses are to be referred to without discrimination, they will be simply referred to as a bus.

Here, that the processing elements are close to each other represents that in a case, for example, where processors constituting the multiprocessor system 1 are integrated on one semiconductor, a distance between the processors is short. In this case, the local buses 3-1 to 3-12 and the global buses 5-1 to 5-14, and the bridges 4-1 to 4-12 are also integrated on the same semiconductor. On the other hand, in a case where with each processor integrated on a separate semiconductor, these plurality of semiconductors are packaged on a substrate, it represents that a distance between the processors on the substrate is short. In this case, the local buses 3-1 to 3-12 and the global buses 5-1 to 5-14, and the bridges 4-1 to 4-12 are packaged on the substrate. One of the advantages of integrating many processors and buses on one semiconductor is that a large band width can be used for communication between processors. In addition, even when each processor is packaged on a separate semiconductor, improvement in packaging techniques enables a larger than conventional band width to be used for communication between processors.

The processing elements are arranged on the multiprocessor system 1 to have a two-dimensional array so that communication is conducted between not less than one processing element adjacent to each other in a lateral direction using the local buses. To each local bus, one bridge is connected, so that communication between the bridges is realized by the global buses 5-1 to 5-6 in the lateral direction and the global buses 5-7 to 5-14 in the vertical direction. The global bus in the lateral direction connects not less than one bridge adjacent to each other in the lateral direction and as illustrated in FIG. 1, a plurality of global buses connect one line of bridges in the lateral direction. Two adjacent global buses in the lateral direction have their end points connected with one bridge through which communication is conducted. The global bus in the vertical direction connects not less than one bridge adjacent to each other in the vertical direction. With respect to global buses in the vertical direction, similar to the global buses in the lateral direction, a plurality of global buses connect one line of bridges in the vertical direction. The local buses and the global buses are constituted by a plurality of channels as will be described later.

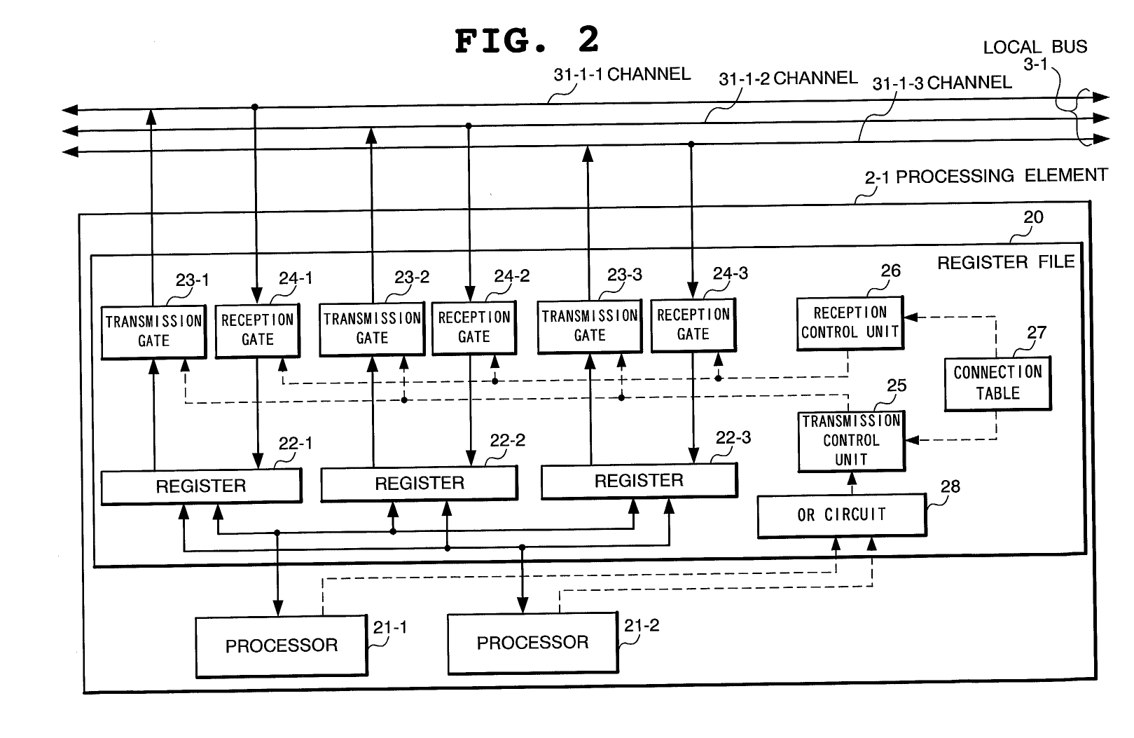

FIG. 2 shows a structure of the processing element 2-1 according to the present embodiment. All of the processing elements 2-2 to 2-24 have the same structure as that of the processing element 2-1. The processing element 2-1 is composed of a register file 20 and processors 21-1 and 21-2 for communicating with each other by sharing the register file 20. The register file 20 is composed of a plurality of registers 22-1 to 22-3 physically shared by the processors 21-1 and 21-2, transmission gates 23-1 to 23-3 and reception gates 24-1 to 24-3 each connecting to each one register, a transmission control unit 25 for controlling all the transmission gates, a reception control unit 26 for controlling all the reception gates, a connection table 27 for supplying the transmission control unit 25 and the reception control unit 26 with connection information between the local buses and the registers, and an OR circuit 28 for summing transmission requests from the respective processors 21-1 and 21-2. Although in the present embodiment, the three registers 22-1 to 22-3 are shared by the two processors 21-1 and 21-2, the number of shared registers is not limited to three and the number of the processors is not limited to two either.

As illustrated in FIG. 2, the local bus 3-1 is composed of a plurality of channels 31-1-1 to 31-1-3. Each channel has a one-to-one correspondence to each of the registers 22-1 to 22-3 on the register file in the present embodiment. Each of the channels 31-1-1 to 31-1-3 is a data channel equivalent to a width of one register.

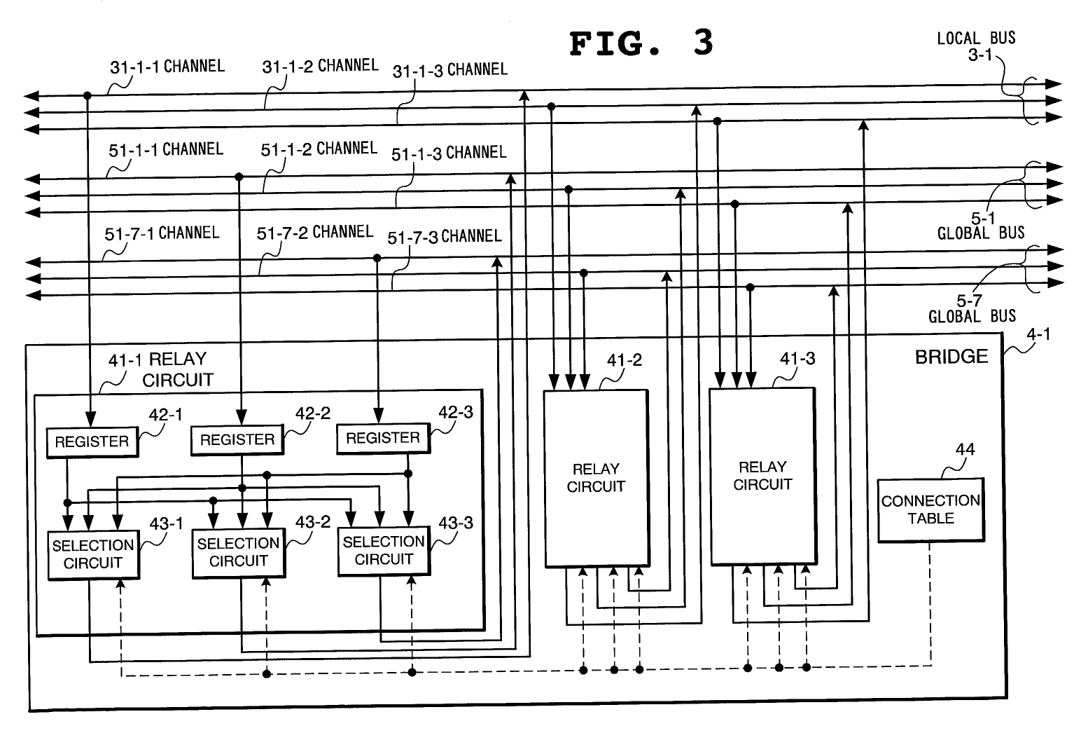

FIG. 3 shows a structure of the bridge 4-1 in the present embodiment. Although the bridges 4-2 to 4-12 basically have the same structure as that shown in the figure, the number of registers 42-1 to 42-3 and the number of selection circuits 43-1 to 43-3 in a relay circuit vary with the number of buses connected to the bridge. The bridge 4-1 is composed of relay circuits 41-1 to 41-3 provided corresponding to the same channel of the respective buses and a connection table 44 for supplying information about connection between the respective buses, and the relay circuit 41-1 is composed of the registers 42-1 to 42-3 provided corresponding to the respective buses and the selection circuits 43-1 to 43-3 for selecting one of their outputs and outputting the same to the bus. Since the relay circuits 41-2 and 41-3 have the same structure as that of the relay circuit 41-1, no illustration is made thereof here.

In addition, as illustrated in FIG. 3, the global buses 5-1 and 5-7 are composed of the same number of a plurality of channels 51-1-1 to 51-5-3 and channels 51-7-1 to 51-7-3, respectively, similarly to the local bus 3-1.

In the present embodiment, not less than one route is determined in advance which is a route connecting the processing elements by a bus and causing no bus contention with other routes and communication is allowed only between the processors based on the determined route. In FIG. 1, for example, among routes connecting the processing element 2-1 and the processing element 2-24 by a bus is a route of the local bus 3-1→ the global bus 5-7→the global bus 5-11→the global bus 5-5→the global bus 5-6→the local bus 3-12. When interprocessor communication by this route is allowed, interprocessor communication by other route using the bus used by this route will not be allowed. However, communication by other route using a bus that is not used by this route is allowed. Interprocessor communication is possible, for example, by a route of the local bus 3-2→the global bus 5-1→the global bus 5-2→the local bus 3-4 as a route from the processing element 2-3 to the processing element 2-8.

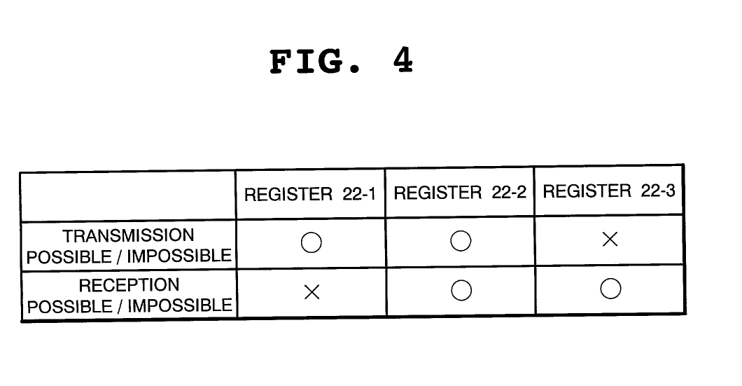

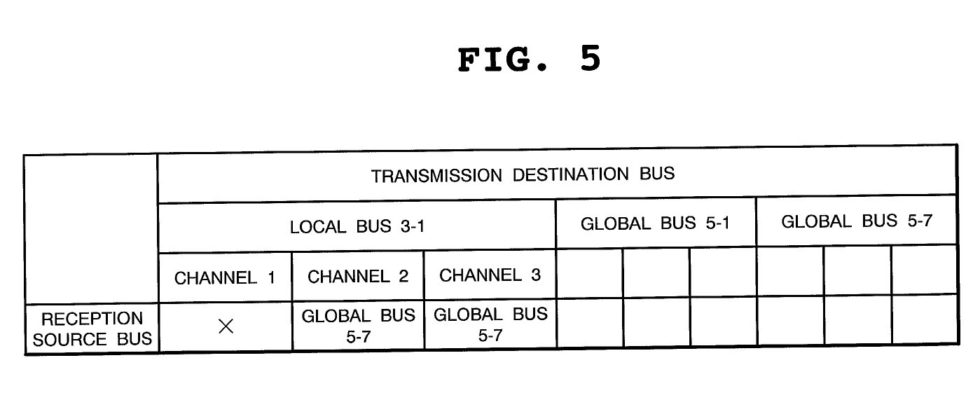

When a combination of processing elements between which interprocessor communication is allowed and a route used therefor are determined, the contents of the connection table 27 in each processing element and the connection table 44 in each bridge are set in advance such that only interprocessor communication by the route is allowed. Setting example of the connection table 27 is shown in FIG. 4 and that of the connection table 44 is shown in FIG. 5.

With reference to FIG. 4, the connection table 27 in the processing element 2-1 holds, with respect to each of the registers 22-1 to 22-3, information whether the relevant register is connectable to the local bus 3-1 or not for each case of transmission and reception. In the example shown in FIG. 4, the register 22-1 and the register 22-2 are allowed to transmit data to the local bus, while the register 22-2 and the register 22-3 are allowed to receive data from the local bus. Here, for the connection table 27, 1-bit information is basically enough which indicates “connectable” or “not connectable”. The reason “connectable” or “not connectable” is set for each register and for each case of transmission and reception in the example of FIG. 4 is that transmission and reception of data to and from only a register whose transmission and reception is truly necessary suppresses wasteful bus drive caused by transmission and reception of data to and from registers requiring no transmission and reception, thereby reducing power consumption. The connection tables in other processing elements are also set to allow only interprocessor communication by an allowed route.

With reference to FIG. 5, the connection table 44 in the bridge 4-1 describes, with respect to each channel in each bus, a bus which receives data transmitted to the relevant channel. The example of FIG. 5 shows that to the channel 1 of the local bus 3-1, transmission is not allowed, while to the channels 2 and 3, transmission of data received from the same channels as those of the global bus 5-7 is possible. The connection tables in other bridges are also set to allow only interprocessor communication by an allowed route.

Next, description will be made of operation of interprocessor communication at the multiprocessor system according to the present embodiment with reference to FIGS. 1 to 5.

First, description will be made of communication between processors belonging to the same processing element. With reference to FIG. 2, the processors 21-1 and 21-2 belonging to the same processing element have no individual register file for each processor and physically share the registers 22-1 to 22-3 having a plurality of ports enabling a plurality of processors to simultaneously read and write similarly to the second conventional technique. Therefore, referring to a register used by a transmission source processor by other processor realize interprocessor communication without physical data transfer.

Next, communication between processing elements connected to the same local bus will be described with respect to the processing elements 2-1 and 2-2. Since the processing elements 2-1 and 2-2 have the same structure, FIG. 2 will be referred to for both elements. When the processor 21-1 or 21-2 in the processing element 2-1 makes a transmission request to the transmission control unit 25, the transmission control unit 25 refers to the connection table 27 to determine whether transmission is possible or not and when transmission is possible, determines a register which conducts transmission. As to a transmission request from the processor, the unit 25 designates whether each register conducts transmission or not and as to transmission requests from a plurality of processors, the OR circuit 28 takes a logical sum of each register and transmits the same to the transmission control unit 25. When the register to which the transmission request is made is indicated to be allowed to conduct transmission at the connection table 27, the transmission control unit 25 informs a transmission gate corresponding to the register in question of the transmission request. Upon receiving the transmission request, the transmission gate outputs the contents of the register to the local bus 3-1. When the register to which the transmission request is made is indicated not to be allowed to conduct transmission at the connection table 27, the transmission control unit 25 rejects the transmission request to refrain from giving the instruction to the transmission gate.

In the processing element 2-2, the reception control unit 26 controls switching of the reception gates 24-1 to 24-3. The reception control unit 26 refers to the connection table 27 and with respect to a register set to be allowed to receive data, informs to a reception gate corresponding to the register in question that reception is possible. The reception gate monitors a local bus and when data is output on a connected channel by other processing element and reception is allowed by the reception control unit, inputs the data from the local bus to the register.

Communication between processing elements connected to the same local bus is thus realized requiring one clock of time. More specifically, data transmitted from a register file of a transmission side processing element at a certain clock is written into a register file of a reception side processing element at the subsequent clock.

Next, communication between distant processing elements will be described. As an example, description will be made of communication between the processing elements 2-1 and 2-24 by a route, which is allowed in advance, of the local bus 3-1→the global bus 5-7→the global bus 5-11→the global bus 5-5→the global bus 5-6→ local bus 3-12.

Data output from the processing element 2-1 to the local bus 3-1 is conducted in the same manner as that described for the communication from the processing element 2-1 to the processing element 2-2. The bridge 4-1, when data is output to each channel on the connected local bus 3-1 or global buses 5-1 and 5-7, takes the data into the registers in the relay circuits 41-1 to 41-3. The selection circuit refers to the connection table 44 and outputs data applied from a bus designated by the table to the bus connected to itself. Thus, the data output from the processing element 2-1 to the local bus 3-1 is relayed to the global bus 5-1. The bridges 4-5, 4-9, 4-11 and 4-12 relay data in the same manner, so that the data ultimately arrives at the local bus 3-12. The processing element 2-24 takes in the data output onto the local bus 3-12 into the register file in the same manner as described with respect to the communication from the processing element 2-1 to the processing element 2-2.

Communication between processing elements connected to different local buses is thus realized requiring a time of (1+n) clock, with the number of bridges passed through denoted as n. More specifically, since each bridge conducts switching operation of selectively receiving data passing through a bus and outputting the data at the subsequent clock, as long delay as the amount equivalent to the number of stages of bridges passed through is added to a time of communication between processing elements connected to the same local bus.

Since in the multiprocessor system according to the present embodiment, processors in the same processing element physically share a register file, spontaneous interprocessor communication is possible and between processing elements connected to the same local bus, communication can be conducted at as few as one clock. Accordingly, by allocating independent parallel processing to each processing element or allocating independent parallel processing on a basis of two processing elements connected to the same local bus, execution of a plurality of parallel processings is enabled at a high speed. In addition, since even communication between processing elements connected to different local buses is enabled through a global bus or a bridge, independent parallel processing can be assigned on a basis of two processing elements connected to different local buses.

The entire structure of a second embodiment of the multiprocessor system to which the present invention is applied is the same as that shown in FIG. 1 with the only difference being that structures of a processing element and a bridge are different.

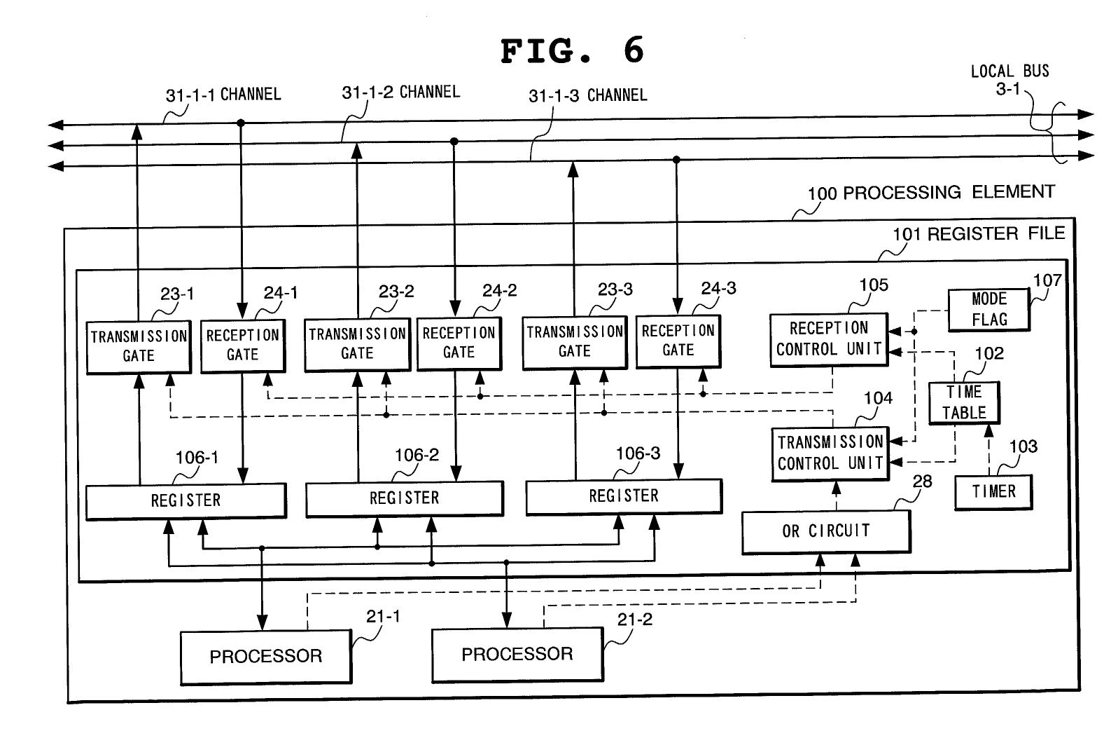

FIG. 6 shows a structure of a processing element 100 according to the present embodiment. The processing element 100 has approximately the same structure as those of the processing elements 2-1 to 2-24 according to the first embodiment with the only difference being that a register file 101 is not provided with the connection table 27 and in place thereof, provided with a time table 102 for supplying a transmission control unit 104 and a reception control unit 105 with connection information for each time, and with a timer 103 for supplying the time table 102 with the current time and that operation of the transmission control unit 104 and the reception control unit 105 differs from that of the first embodiment. In addition, registers 106-1 to 106-3 physically shared by processors 21-1 and 21-2 belonging to the same processing element not only hold data but also have a write inhibition flag and a read inhibition flag for holding write-enabled or -disabled and read-enabled or -disabled states. Further provided is a mode flag 107 for designating an operation mode of the present processing element 100.

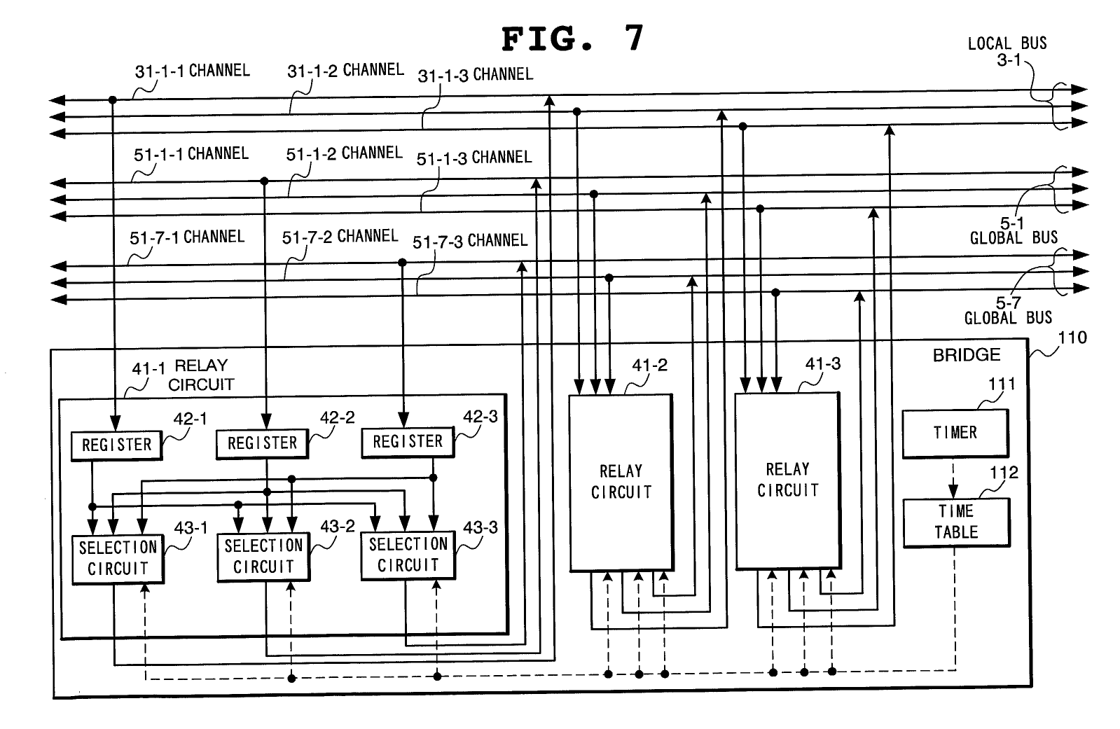

FIG. 7 shows a structure of a bridge 110 according to the present embodiment. The bridge 110 has approximately the same structure as those of the bridges 4-1 to 4-12 according to the first embodiment with the only difference being that the connection table 44 is replaced by a time table 112 for supplying the relay circuits 41-1 to 41-3 with connection information for each time and a timer 111 for supplying the time table 112 with the current time.

In the present embodiment, as well as the first embodiment, not less than one route is determined in advance which is a route connecting processing elements by a bus and causing no bus contention with other routes. According to the present embodiment, however, time-divisional use of a local bus and a global bus also enables interprocessor communication by a route causing no bus contention with other route by varying transmission times. In FIG. 1, for example, among routes connecting the processing element 2-1 and the processing element 2-24 by a bus is a route R1 of the local bus 3-1 →the global bus 5-7→the global bus 5-11→the global bus 5-5→the global bus 5-6→the local bus 3-12. When interprocessor communication by the route R1 is allowed, the first embodiment fails to allow interprocessor communication by other route using the bus used by the route R1. However, scheduling a time when each bus is used by the route R1 in advance allows the bus in question to be used by other route at a time when the bus is not used by the route R1.

Therefore, in the present embodiment, the timers 103 and 111 provided in each processing element and each bridge are all synchronized with each other to be a cyclic counter for counting one time each from time 1 up to time n and then returning to time 1 again to continue counting up. Then, assume a time from time 1 to time n as one cycle, a transmission schedule for communication between respective processors is assigned in advance in which no bus contention occurs within the one cycle. For example, the route R1 is scheduled such that the local bus 3-1 is used at time 1, the global bus 5-7 at time 2, . . . , the local bus 3-12 at time 6 and for example, a route R2 for use in interprocessor communication between the processing elements 2-2 and 2-10 is scheduled such that the local bus 3-1 is used at time 2, the global bus 5-7 at time 3 and the local bus 3-5 at time 4. One cycle may be not shorter than a cycle in which at least the longest distance route is scheduled and it can be longer. A plurality of interprocessor communications by the same route can be scheduled within one cycle.

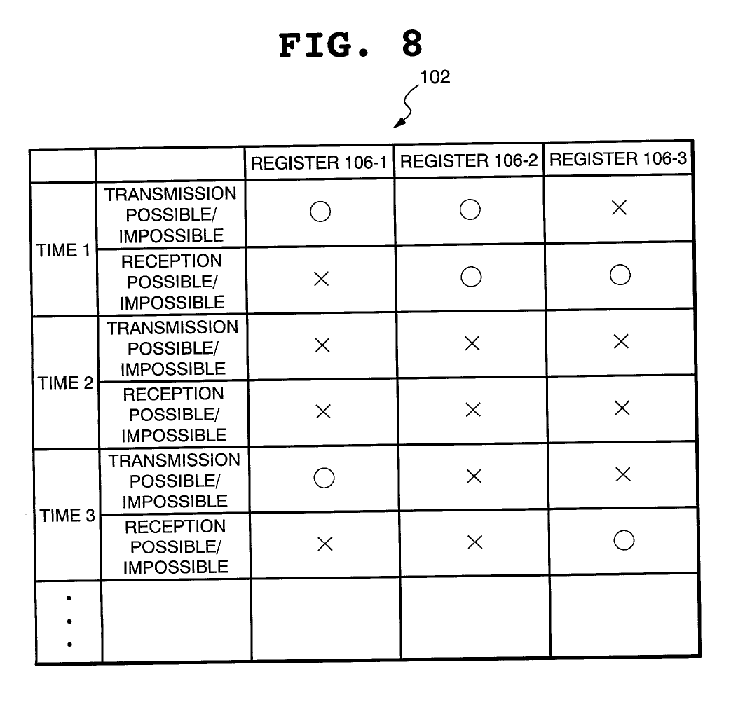

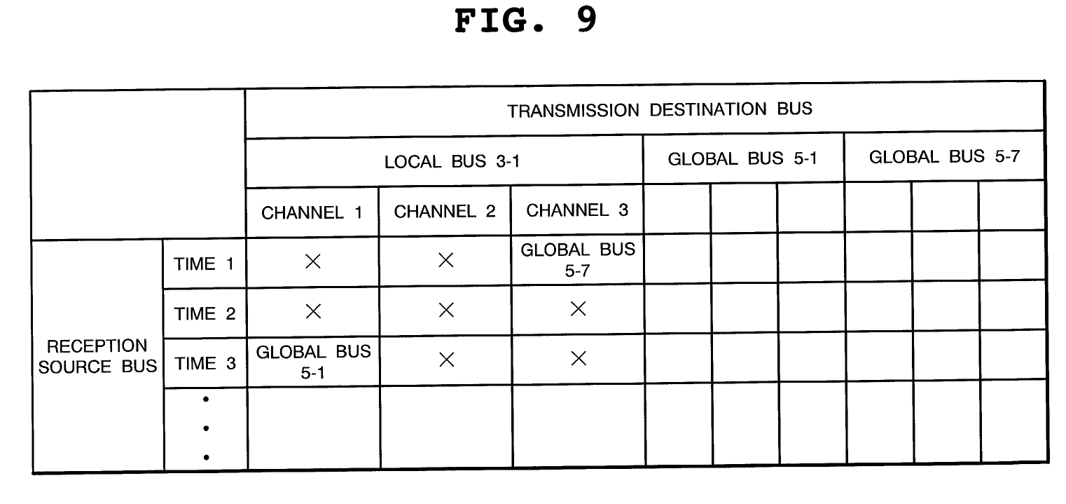

When the transmission schedule of each interprocessor communication is thus determined, the contents of the time table 102 in each processing element and the time table 112 in each bridge are set in advance such that only interprocessor communication by the determined schedule is allowed. Setting example of the time table 102 is shown in FIG. 8 and that of the time table 112 is shown in FIG. 9.

With reference to FIG. 8, the time table 102 in each processing element holds, with respect to each time and register, information whether the contents of the relevant register are transmittable to the local bus or not and whether data on the local bus is receivable by the register or not. The example in FIG. 7 indicates that at time 1, the register 106-1 and the register 106-2 are allowed to transmit data to the local bus, while the register 106-2 and the register 106-3 are allowed to receive data from the local bus and at time 2, none of data transmission and reception is allowed. Here, for the time table 102, 1-bit information is basically enough which indicates “connectable” or “not connectable” at each time. Setting made for each register and for each case of transmission and reception in the example of FIG. 8 is intended to prevent useless data transmission and reception.

With reference to FIG. 9, the time table 112 in each bridge describes, for each channel in each bus, a bus which receives data to be transmitted to the relevant channel with respect to each time. The example of FIG. 9 shows that with respect to the respective channels of the local bus 3-1, at time 1, transmission is not possible to the channels 1 and 2, while to the channel 3, data received from the same channel as that of the global bus 5-7 is transmittable, and at time 2, data transmission is impossible to each channel.

Next, description will be made of operation of interprocessor communication at the multiprocessor system according to the present embodiment mainly with respect to the difference from the first embodiment with reference to FIGS. 6 to 9. Since the entire operation of the present embodiment is the same as that of the first embodiment, description will be here made of operation of the processing element 100 and the bridge 110.

The processing element 100 has two kinds of operation modes, a synchronous operation mode and an asynchronous operation mode and which operation mode is activated is set at the mode flag 107. All the processors in the processing element operable in the synchronous operation mode are programmed by the same timer as the timer 103 so as to operate in synchronization with each other according to a transmission schedule set in advance and also in synchronization with the register file and the bridge. In other words, all of these operate using the same time to enable communication without confirmation and acknowledgement. On the other hand, since processors in the processing element operable in the asynchronous operation mode operate not in synchronization with each other and with the register file and bridge either, any means for control is required for communication between processors.

First, operation of the processing element 100 in the synchronous operation mode will be described. When the processor 21-1 or 21-2 in the processing element 100 makes a transmission request to the transmission control unit 104, the transmission control unit 104 refers to the time table 102 to determine a register which conducts transmission. As to a transmission request from a processor, the unit 104 designates whether each register conducts transmission or not and as to transmission requests from a plurality of processors, the OR circuit 28 takes a logical sum of each register and informs the same to the transmission control unit 104. When at the time table 102, the register to which the transmission request is made is indicated to be allowed to conduct transmission at the time given by the timer 103, the transmission control unit 104 informs a transmission gate corresponding to the register in question of the transmission request. Upon receiving the transmission request, the transmission gate outputs the contents of the register to the local bus 3-1. When the register to which the transmission request is made by the processor is indicated not to be allowed to conduct transmission at the time table 102, the transmission control unit 104 rejects the transmission request although such case will not occur as long as setting of the time table 102 or a program to be applied to the processor is free of err since the processor and the register file operate in synchronization each other.

Next, operation of the processing element 100 in the asynchronous operation mode will be described. When the processor 21-1 or 21-2 in the processing element 100 makes a transmission request to the transmission control unit 104, the transmission control unit 104 refers to the time table 103 to determine a register which conducts transmission. When the determination is made that the register to which the transmission request is made is allowed to conduct transmission, the same operation as that of the synchronous operation mode is conducted. Since in the asynchronous operation mode, the processor and the register file are not synchronized with each other, there will be a register to which a transmission request is not transmissible. In this case, the transmission request to the register in question is held in the transmission control unit 104 and a write inhibition flag of the register in question is set to set the register at a write-inhibited state. As time passes to make the register related to the held transmission request allowed to conduct transmission, the transmission control unit 104 informs a transmission gate corresponding to the register in question of the transmission request and at the same time abandons the transmission request to the register in question and resets the write inhibition flag to release the write-inhibited state.

Operation of data output from the local bus to a register by the reception control unit 105 is the same as that of the first embodiment with the only difference being that connection information supplied from the time table 102 to the reception control unit 105 changes with time. In a case where the processors 21-1 and 21-2 set the register at the read-inhibited state, when data reception occurs at the register in question, the reception control unit 105 releases the register in question from the read-inhibited state. This is intended to indicate that necessary data is yet to arrive in the processing element in the asynchronous operation mode by setting a register which is scheduled to store the data in question at the read-inhibited state until the data in question arrives.

Operation of the bridge in the present embodiment is approximately the same as that of the bridge 4-1 in the first embodiment with the only difference being that connection information supplied from the time table 112 changes with time.

Since the multiprocessor system according to the present embodiment uses the local bus and the global bus in a time-divisional manner, a communication route can be set between all the processing elements unlike the multiprocessor system of the first embodiment. Although the transmission side processing element and the reception side processing element are basically set at the same operation mode, when the transmission side processing element is in the synchronous operation mode, the reception side processing element can be set in the asynchronous operation mode.

The entire structure of a third embodiment of the multiprocessor system to which the present invention is applied is the same as that shown in FIG. 1 with the only difference being that structures of a processing element and a bridge are different. In addition, in the present embodiment, not only data is transmitted on a bus but also a connection number is at the same time transmitted as control information for controlling a data communication path. Therefore, a local bus and a global bus each have one control channel as will be described later.

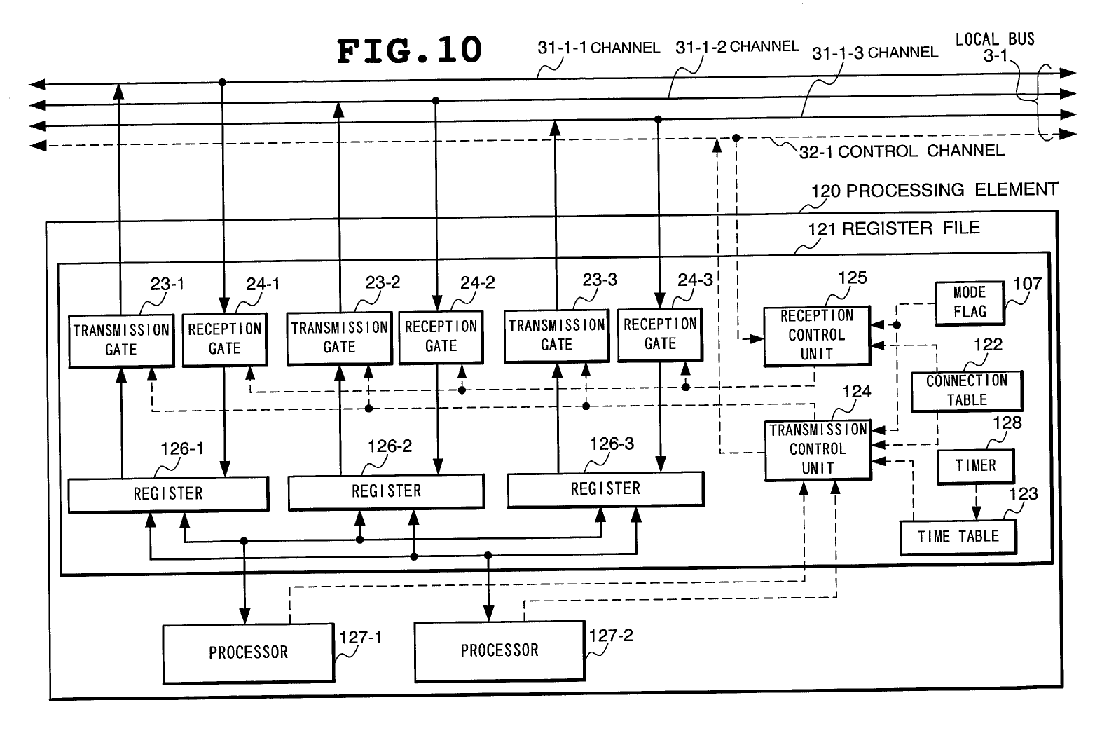

FIG. 10 shows a structure of a processing element 120, as well as a structure of a local bus according to the present embodiment. All the local buses, as illustrated in the local bus 3-1, have one control channel 32-1 in addition to data channels 31-1-1 to 31-1-3. The processing element 120 has approximately the same structure as those of the processing elements 2-1 to 2-24 according to the first embodiment with the only differences being that a register file 121 is not provided with the connection table 27 but in place provided with a connection table 122 and time table 123 for supplying a transmission control unit 124 and a reception control unit 125 with connection information, and a timer 128 for supplying the time table 123 with the current time and that operation of the transmission control unit 124 and the reception control unit 125 differs from that of the first embodiment. In addition, the processing element 120 has no OR circuit and each of the processors 127-1 and 127-2 is directly connected to the transmission control unit 124. Since registers 126-1 to 126-3 hold not only data but also information whether write is enabled or not and read is enabled or not, they have a write inhibition flag and a read inhibition flag. Further provided is a mode flag 107 for designating an operation mode of the present processing element 120.

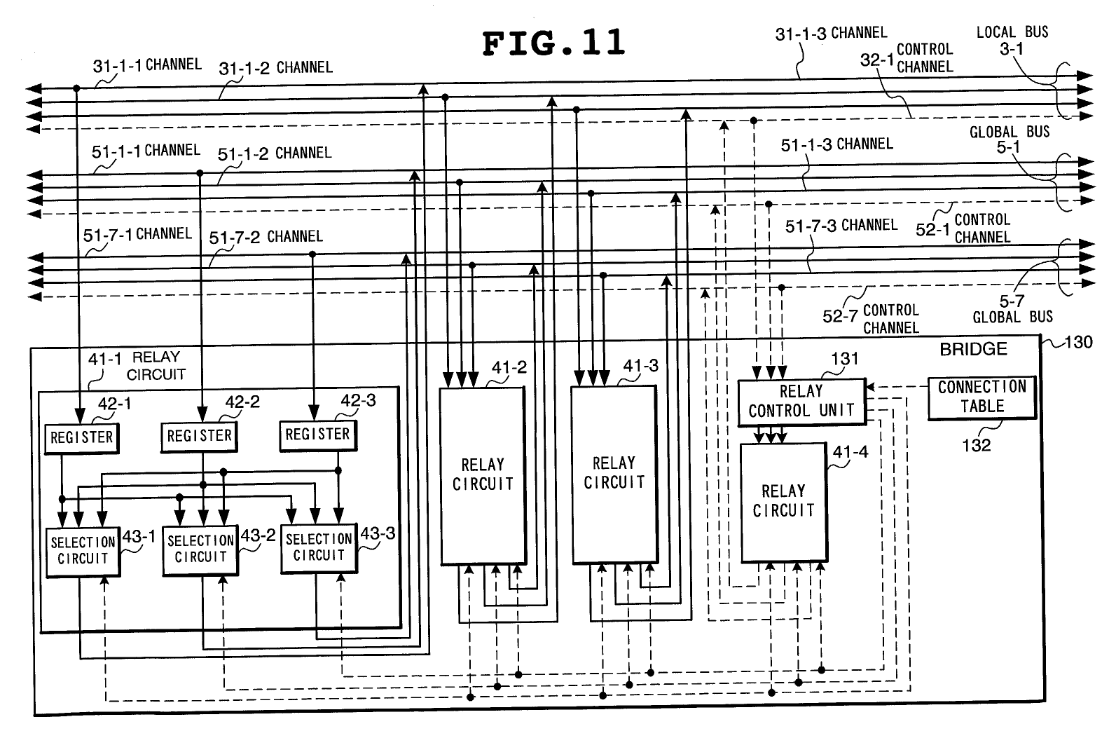

FIG. 11 shows a structure of a bridge 130, as well as a structure of a global bus according to the present embodiment. As illustrated in the global buses 5-1 and 5-7, all the global buses have one control channel 52-1, 52-7, respectively, in addition to the data channels 51-1-1 to 51-1-3 and 51-7-1 to 51-7-3. The bridge 130 has approximately the same structure as those of the bridges 4-1 to 4-12 according to the first embodiment with the only difference being that it is provided with not the connection table 44 but a relay circuit 41-4 for relaying control information on the control channel, a relay control unit 131 for supplying the relay circuits 41-1 to 41-4 with connection information based on control information on the control channel and a connection table 132 for supplying the relay control unit 131 with connection information.

In the present embodiment, as well as the first embodiment, not less than one route is determined in advance which is a route connecting the processing elements by a bus and causing no bus contention with other routes. In addition, similarly to the second embodiment, according to the present embodiment, time-divisional use of a local bus and a global bus also enables interprocessor communication by a route on which no bus contention with other routes occurs by varying transmission times. In the present embodiment, moreover, when the number of communication routes passing through a bridge is small, use of a connection number as control information for controlling a data communication path enables reduction in the capacity of a table to be held by the bridge in question. More specifically, while according to the second embodiment, each bridge requires a time table having entries from time 1 to time n irrespective of the number of routes passing through the own bridge, the present embodiment only requires a connection table having as many entries as the number of routes passing through the own bridge.

In addition, paying attention to the fact that even in interprocessor communications by a plurality of routes on which bus contention occurs, when the interprocessor communications by these plurality of routes are not activated at the same time, no bus contention actually occurs, the present embodiment is designed such that a transmission source processor is allowed to alternatively activate different interprocessor communications at the same time. In FIG. 1, for example, in a case where allowed are a first interprocessor communication between the processing element 2-1 and the processing element 2-24 by the route R1 of the local bus 3-1→the global bus 5-7→the global bus 5-11→the global bus 5-5→the global bus 5-6 →the local bus 3-12 and a second interprocessor communication between the processing element 2-1 and the processing element 2-10 by the route R2 of the local bus 3-1→the global bus 5-7→the local bus 3-5, the second embodiment needs to vary a time of outputting data from the processing element 2-1 to the local bus 3-1 with the first and the second interprocessor communications. In the present embodiment, on the premise that the first interprocessor communication and the second interprocessor communication are not activated at the same time, both the communications are allowed to designate which communication is desired by a number called a connection number when a transmission request from a processor is made. The present embodiment employs an arbitrary number as a connection number. To prevent activation of contending interprocessor communications at the same time including prevention of simultaneous activation of the first and the second interprocessor communications, there are two methods, one of which is ensuring the prevention on a processor side and the other is ensuring the same on the side of a transmission control unit of a register file. The former is the method by a synchronous operation mode and the latter is the method by the same time table as that of the second embodiment.

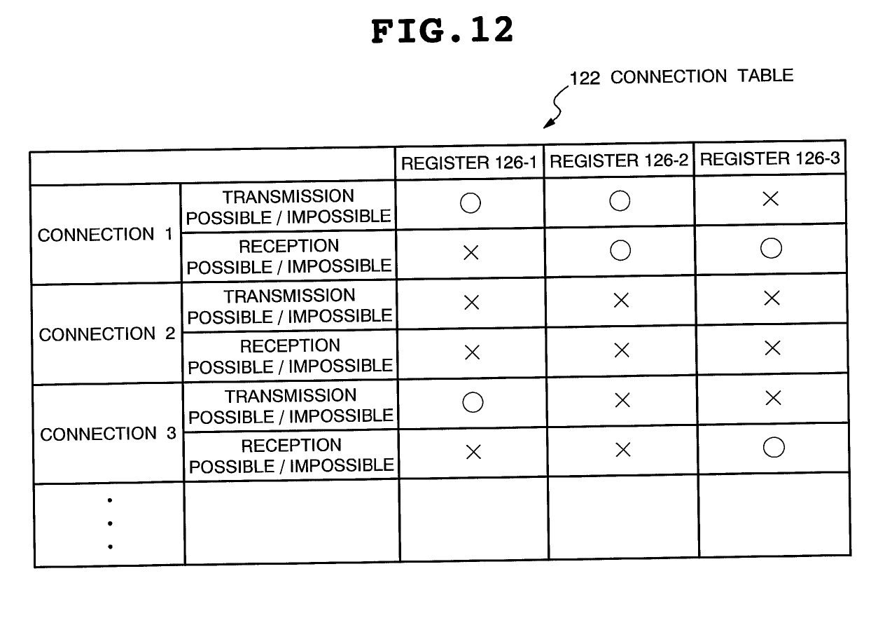

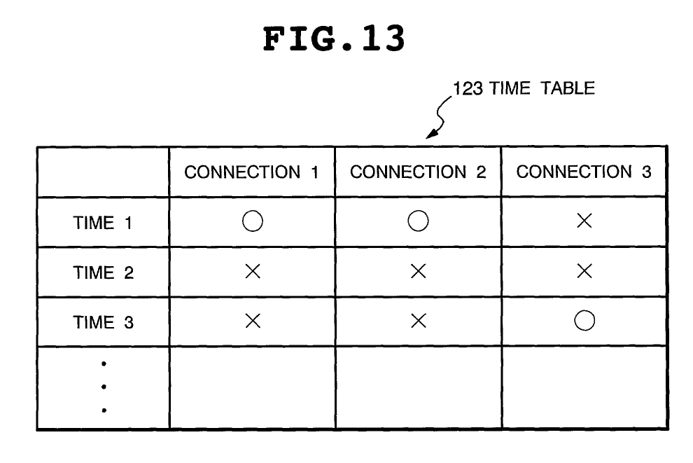

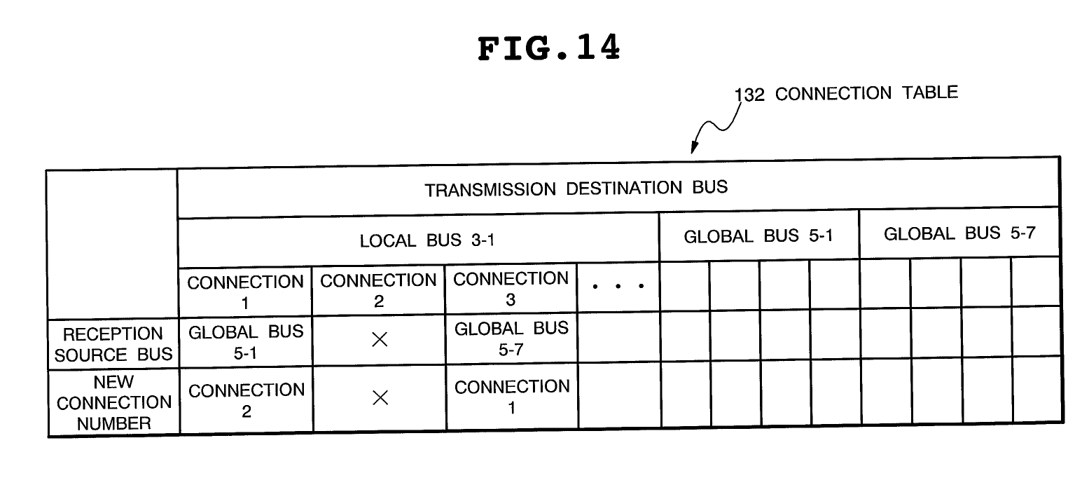

When the transmission schedule of each interprocessor communication is determined, the contents of the connection table 122 in each processing element and the connection table 132 in each bridge are set in advance and the contents of the time table 123 in each processing element are also set in advance such that only interprocessor communication by the determined schedule is allowed. Setting example of the connection table 122 is shown in FIG. 12, that of the time table 123 is shown in FIG. 13 and that of the connection table 132 is shown in FIG. 14.

With reference to FIG. 12, the connection table 122 in each processing element holds, for each connection number and each register, information whether the contents of the relevant register are transmittable to the local bus or not and information whether data on the local bus is receivable by the register or not. The example in FIG. 11 shows that with a connection 1, data is transmittable from the register 126-1 and the register 126-2 to the local bus and data from the local bus is receivable at the register 126-2 and the register 126-3 and with a connection 2, none of data transmission and reception is allowed.

With reference to FIG. 13, the time table 123 of each processing element holds information whether the contents are transmittable and receivable at each time with respect to each connection number. In the example of FIG. 13, at time 1, transmission is possible by the connections 1 and 2, while at time 2, transmission is impossible by any of the connections.

With reference to FIG. 14, the connection table 132 in each bridge describes, for each bus, a bus as a transmission destination of data received from the relevant bus and a connection number for use in the transmission. The example of FIG. 14 shows that from each channel of the local bus 3-1, data of the connection 1 is received and transmitted to each channel of the global bus 5-1 as the connection 2 and data of the connection 3 is received and transmitted to each channel of the global bus 5-7 as the connection 1. Since change of a connection number is not always necessary for all the connections, a new connection number may be indicated “NULL” in some cases and in such a case, the bridge refrains from changing a connection number.

Next, description will be made of operation of interprocessor communication at the multiprocessor system according to the present embodiment with reference to FIGS. 10 to 14. Since the entire operation of the present embodiment is the same as that of the first embodiment, description will be here made of operation of the processing element 120 and the bridge 130.

Similarly to the second embodiment, the processing element 120 of the present embodiment has two kinds of operation modes, a synchronous operation mode and an asynchronous operation mode. Description will be first made of operation of the processing element 120 in the synchronous operation mode.

When the processor 127-1 or 127-2 in the processing element 120 makes a transmission request to the transmission control unit 124, the transmission control unit 124 refers to the connection table 122 to determine a register which conducts transmission. As to a transmission request from a processor, a connection number by which the transmission is made is output to the transmission control unit 124. The transmission control unit 124 refers to the connection table 122 using the given connection number to determine a register which conducts transmission, informs a transmission gate corresponding to the relevant register of the transmission request, and outputs the connection number to the control channel 32-1. Upon receiving the transmission request, the transmission gate outputs the contents of the register to the local bus 3-1. In a case of the synchronous operation mode, since each processor operates in synchronization with each other, a plurality of processors will make no transmission request to the transmission control unit 124 simultaneously as long as a program of each processor is free of err. In case where the transmission requests are made simultaneously, the transmission control unit 124 is allowed to abandon the transmission requests. In addition, in the synchronous operation mode, since none of such data transmission is made from different processing elements as causes contention for a bus on the way, the processing elements refrain from using the time table 123 at the time of transmission control.

Next, operation of the processing element 120 in the asynchronous operation mode will be described. When the processor 127-1 or 127-2 in the processing element 120 makes a transmission request to the transmission control unit 124, the transmission control unit refers to the time table 123 and the connection table 122 to determine a register which conducts transmission. Since in the asynchronous operation mode, a processor in the processing element operates not in synchronization with other processors, if transmission control is conducted according to a request from the processor in question, there is a possibility that data will contend with data output from other processor on any of the buses. Therefore, in the asynchronous operation mode, such a transmission schedule as causes no contention is set in advance at the time table 123 and the transmission control unit 124 conducts transmission control according to the table.

Upon receiving a transmission request from each processor, the transmission control unit 124 first refers to the time table 123 using the current time of the timer 128 and the connection number in the transmission request to determine whether transmission is possible or not. If a plurality of transmission requests are simultaneously transmittable, select one transmission request from among them. Operation for the selected transmission request is the same as that conducted in the synchronous operation mode, in which data transmission is conducted after determining a register which conducts transmission with reference to the connection table 122. A transmission request determined not to be transmittable and a transmission request determined to be transmittable but not selected are held in the transmission control unit 124 and with reference to the connection table 122, registers corresponding to the transmission requests in question are specified to set these registers at the write-inhibited state. As time passes to make the held transmission request transmittable and make the transmission control unit 124 select the request, data is transmitted in the same manner as that of the synchronous operation mode. Then, release the transmission requests in question and when all the transmission requests to the register which has conducted transmission are released, release write inhibition of the registers in question.

The reception control unit 125 controls switching of the reception gates 24-1 to 24-3 while monitoring the control channel 32-1. Upon receiving a connection number from the control channel 32-1, the reception control unit 125 refers to the connection table 122 using the connection number in question. Then, with respect to a register set to be allowed to receive data at the connection table 122, the unit 125 informs a reception gate corresponding to the register in question that reception is allowed. The reception gate monitors the local bus 3-1 and when data is output onto a connected channel and reception is allowed by the reception control unit 125, the gate inputs data from the local bus 3-1 into the register. If the processors 127-1 and 127-2 set the register at the read-inhibited state, when data reception occurs at the register in question, the reception control unit 125 releases the read inhibition of the register. This is intended to indicate that necessary data is yet to arrive in a processing element in the asynchronous operation mode by setting a register which is scheduled to store the data at the read-inhibited state until the data arrives.

When data is output onto each channel of the local bus 3-1 or the global buses 5-1 and 5-7 connected, the bridge 130 takes in the data into the registers in the relay circuits 41-1 to 41-3. In addition, when a connection number is output onto the control channel on each bus, the relay control unit 131 takes in the number and refers to the connection table 132 to determine a destination of the connection in question and informs a reception source bus to a selection circuit in the relay circuits 41-1 to 41-4 as the destination of the connection in question. Then, the relay control unit 131 replaces the connection number and transmits a new connection number to the register in the relay circuit 41-4. The selection circuit in the relay circuit 41-1 to 41-4 outputs data from the register connected by a bus designated by the relay control unit 131 to the bus connected to itself.

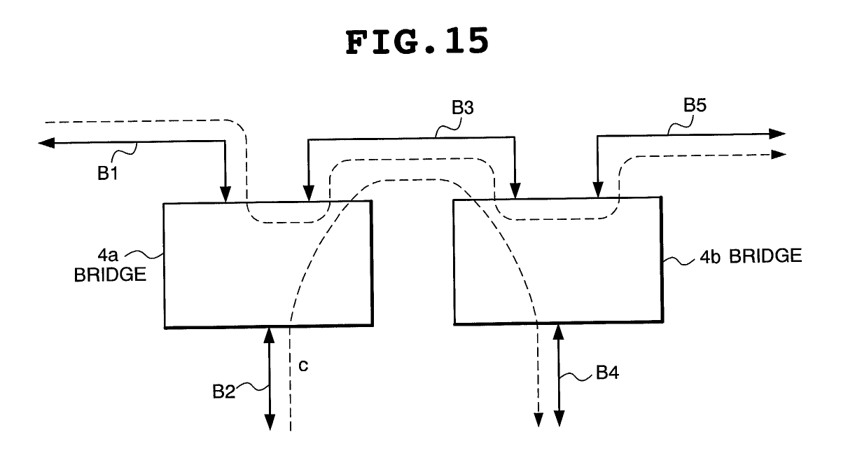

Here, the object of replacement of a connection number in the bridge 130 in the present embodiment is to reduce the total number of connection numbers at the time when a processor makes a transmission request by enabling different interprocessor communications to designate the same connection number. More specifically, assume two connections as illustrated in FIG. 15, a connection C1 passing through a bus B1, a bridge 4a, a bus B3, a bridge 4b and a bus B5 and a connection C2 passing through a bus B2, the bridge 4a, the bus B3, the bridge 4b and a bus B4, since the same bus B3 is used, the connections C1 and C2 need to be assigned different connection numbers on the bus B3. However, on other buses than the bus B3, the same connection number causes no problem. Accordingly, a transmission side processor and a reception side processor of the connections C1 and C2 use the same connection number (e.g. 1), and for the bridge 4a, for example, the connection number of the connection C2 entering from the bus B2 is changed from 1 to, for example, 2 and for the bridge 4b, the connection number of the connection C2 entering from the bus B3 is returned from 2 to 1. This arrangement enables different interprocessor communications to conduct transmission and reception using the same connection number. It is clearly understood that an embodiment in which no connection number is replaced is also included in the present invention.

Since the multiprocessor system according to the present embodiment uses a local bus and a global bus in a time-divisional manner, a communication route can be set between all the processing elements unlike the multiprocessor system of the first embodiment. In addition, when the number of connections passing through a bridge is small, the size of a table to be held by the bridge can be made smaller than that of the second embodiment. Although a transmission side processing element and a reception side processing element are basically set in the same operation mode, when the transmission side processing element is in the synchronous operation mode, the reception side processing element can be set in the asynchronous operation mode.

The entire structure of a fourth embodiment of the multiprocessor system to which the present invention is applied is the same as that shown in FIG. 1 with the only difference being that structures of a processing element and a bridge are different. In addition, in the present embodiment, a connection number for controlling a data communication path is transmitted not on a bus basis as in the third embodiment but independently on a channel basis. Therefore, a local bus and a global bus have an independent control channel for each channel as will be described later.

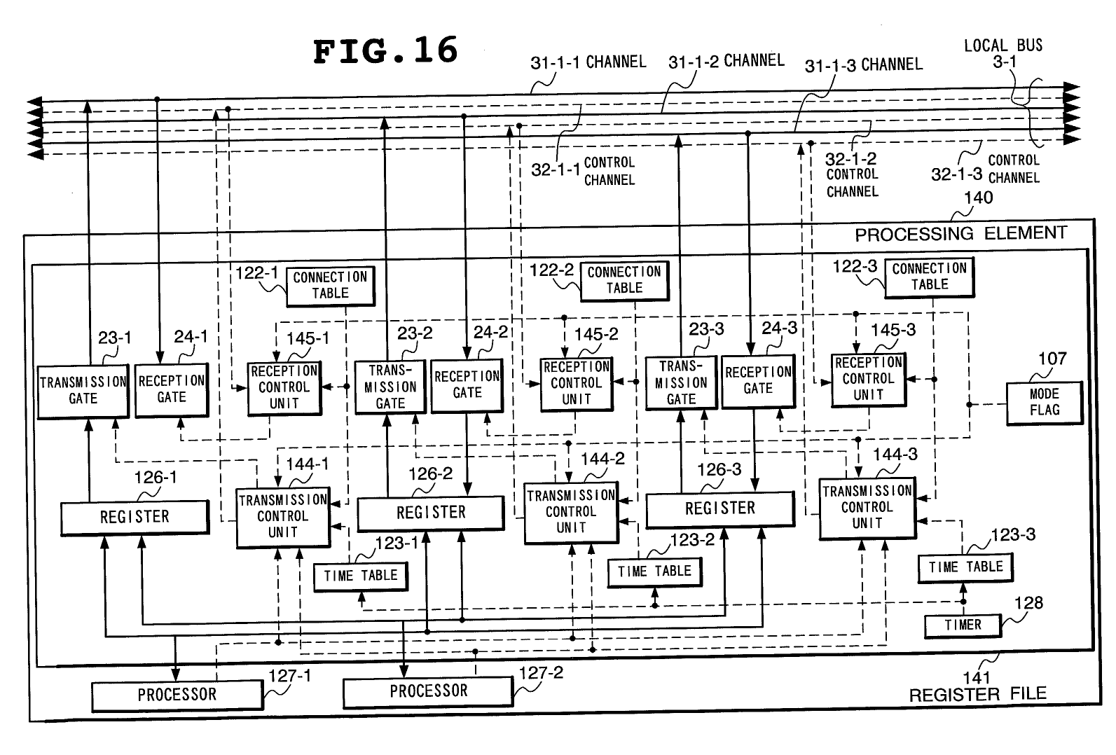

FIG. 16 shows a structure of a processing element 140, as well as a structure of the local bus 3-1 according to the present embodiment. All the local buses, as illustrated in the local bus 3-1, have control channels 32-1-1 to 32-1-3 one-to-one corresponding to each channel in addition to the data channels 31-1-1 to 31-1-3. The processing element 140 has approximately the same structure as that of the processing element 120 according to the third embodiment with the only difference being that a register file 141 includes transmission control units 144-1 to 144-3 and reception control units 145-1 to 145-3, connection tables 122-1 to 122-3 and time tables 123-1 to 123-3 provided corresponding to the respective registers and that operation of the transmission control units 144-1 to 144-3 and the reception control units 145-1 to 145-3 differs from that of the third embodiment. Structures of the connection tables 122-1 to 122-3 and the time tables 123-1 to 123-3 are the same as those of the third embodiment with the only difference being that they are provided for the registers, respectively.

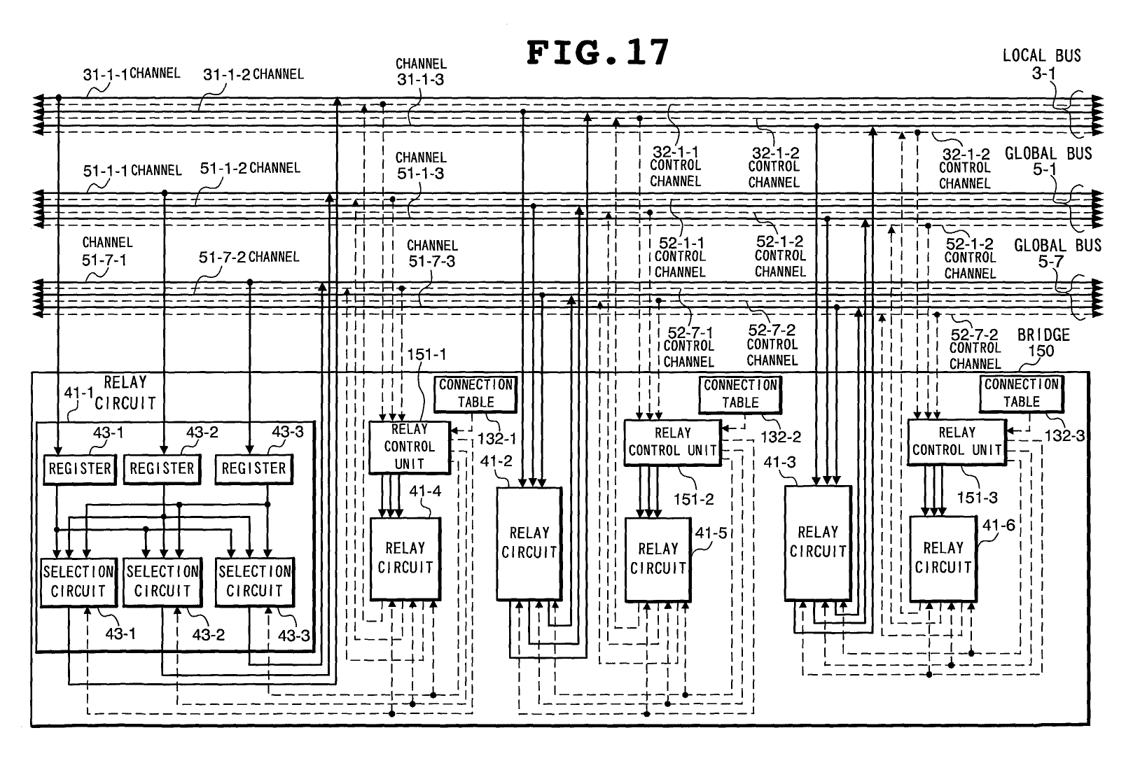

FIG. 17 shows a structure of a bridge 150, as well as a structure of a global bus according to the present embodiment. As illustrated in the global buses 5-1 and 5-7, all the global buses have control channels 52-1-1 to 52-1-3 and 52-7-1 to 52-7-3 one-to-one corresponding to each channel, respectively, in addition to the data channels 51-1-1 to 51-1-3 and 51-7-1 to 51-7-3. The bridge 150 has approximately the same structure as that of the bridge 130 according to the third embodiment with the only difference being that relay circuits 41-4 to 41-6 and relay control units 151-1 to 151-3, and connection tables 132-1 to 132-3 are not shared but provided for each channel. The relay control units 151-1 to 151-3 are equivalent to the function of the relay control unit 131 in the third embodiment divided for each channel and the relay circuits 41-4 to 41-6 and the connection tables 132-1 to 132-3 are equivalent to the function of the relay circuit and the connection table in the third embodiment divided for each channel.

In the present embodiment, since the local bus and the global bus both have an independent control channel for each channel, not only time-divisional multiplex communication but also space-divisional multiplex communication is conducted by controlling communication on a channel basis. In FIG. 1, for example, when allowed are the first interprocessor communication between the processing element 2-1 and the processing element 2-24 by the route R1 of the local bus 3-1→the global bus 5-7→the global bus 5-11→the global bus 5-5 →the global bus 5-6→the local bus 3-12 and the second interprocessor communication between the processing element 2-1 and the processing element 2-10 by the route R2 of the local bus 3-1→the global bus 5-7 →the local bus 3-5, the second embodiment needs to vary a time of outputting data from the processing element 2-1 to the local bus 3-1 with the first and the second interprocessor communications. The third embodiment needs to prevent simultaneous activation of the first interprocessor communication and the second interprocessor communication. According to the present embodiment, however, as long as no contention occurs between a channel corresponding to a register to which data is sent by the first interprocessor communication and a channel corresponding to a register to which data is sent by the second interprocessor communication, space-divisional multiplex communication is possible. As a result, the number of interprocessor communications which can be scheduled is larger than those of the above-described respective embodiments.

When a transmission schedule of each interprocessor communication is determined premised on time-divisional multiplex communication and space-divisional multiplex communication, set the contents of the connection tables 122-1 to 122-3 in each processing element and the connection tables 132-1 to 132-3 in each bridge in advance and set the contents of the time tables 123-1 to 123-3 in each processing element in advance so as to allow only an interprocessor communication according to the determined transmission schedule.

Next, description will be made of operation of interprocessor communication at the multiprocessor system according to the present embodiment with reference to FIGS. 16 and 17 mainly with respect to a difference from the third embodiment. Since the entire operation of the present embodiment is the same as those of the first to the third embodiments, description will be here made of operation of the processing element 140 and the bridge 150.

Similarly to the third embodiment, the processing element 140 of the present embodiment has two kinds of operation modes, a synchronous operation mode and an asynchronous operation mode. Description will be first made of operation of the processing element 140 in the synchronous operation mode.

When a processor makes a transmission request, the processor informs all the transmission control units 144-1 to 144-3 of a connection number. In the present embodiment, since a control channel is prepared independently for each channel to enable simultaneous communication of a plurality of connections on the same bus, a plurality of processors are allowed to make transmission requests simultaneously. The transmission control units 144-1 to 144-3 refer to the connection tables 122-1 to 122-3 using the connection number requested by each processor and with respect to each transmission request, determine whether transmission to a register corresponding to the transmission control unit in question is possible or not. In a case of the synchronous operation mode, since the respective processors operate in synchronization with each other, transmission requests applied from the plurality of processors will not be transmittable simultaneously to the same register as long as no program of each processor is erroneous. In case where the plurality of the transmission requests are made transmittable simultaneously, these transmission requests may be abandoned. Then, at a register allowed to conduct transmission, the transmission request is informed to the transmission gate from the corresponding transmission control unit to output the connection number to which the transmission request is allowed to the corresponding control channel. Upon receiving the transmission request, the transmission gate outputs the contents of the register to the local bus 3-1. Since in the synchronous operation mode, none of such data transmission is conducted from different processing elements as causes contention for a bus on the way, none of the time tables 123-1 to 123-3 is used in the processing elements at the time of transmission control.

Next, operation of the processing element 140 in the asynchronous operation mode will be described. Also in the present embodiment as well as the third embodiment, in the asynchronous operation mode, such a transmission schedule as causes no contention is set in advance in the time tables 123-1 to 123-3 and the transmission control units 144-1 to 144-3 conduct transmission control according to the tables. When receiving a transmission request from the processor, the transmission control units 144-1 to 144-3 refer to the time tables 123-1 to 123-3 and the connection tables 122-1 to 122-3 to determine whether each transmission request is transmittable or not. When a plurality of transmission requests are transmittable at the same time, select one of these transmission requests. Operation for the selected transmission request is the same as that in a case of the synchronous operation mode. Transmission requests determined not to be transmittable and transmission requests determined to be transmittable but not selected are held in the transmission control units 144-1 to 144-3 to set registers corresponding to the relevant transmission requests at the write-inhibited state. As time passes to make the held transmission request transmittable and be selected by the transmission control unit, the transmission control unit informs the corresponding transmission gate of the transmission request and outputs a connection number to which the transmission request is allowed to the corresponding control channel. Then, release the transmission request and when the relevant transmission control unit releases all the transmission requests, release write inhibition of the corresponding register.

The reception control units 145-1 to 145-3 control switching of the reception gates 24-1 to 24-3 while monitoring the control channels 32-1-1 to 32-1-3. Upon receiving connection numbers from the control channels connected thereto, the reception control units 145-1 to 145-3 refer to the connection tables 122-1 to 122-3 using the connection numbers in question. Then, upon determination that a register corresponding to the reception control unit in question is allowed to receive the data, instruct the reception gate connected to the reception control unit in question to input data to the register from the local bus. In a case where the processors 127-1 and 127-2 set the register at the read-inhibited state, when data reception occurs at the register in question, the reception control units 145-1 to 145-3 release the read inhibition of the register.

In the present embodiment, the bridge 150 operates completely independently for each channel. When data is output onto each channel of the local bus 3-1 or the global buses 5-1 and 5-7 connected, the bridge 150 takes in the data into the registers in the relay circuits 41-1 to 41-3. In addition, when a connection number is output onto the control channel on each bus, the relay control units 151-1 to 151-3 take in the number and refer to the connection tables 132-1 to 132-3 to determine a destination of the connection in question and informs a reception source bus to a selection circuit in the relay circuits 41-1 to 41-6 corresponding to a bus as the destination of the connection in question. Then, the relay control unit replaces the connection number as required and transmits a new connection number to the registers in the relay circuits 41-4 to 41-6. The selection circuit outputs data input from the bus instructed by the relay control unit to the bus connected to itself.

Since the multiprocessor system according to the present embodiment uses the local bus and the global bus in a time-divisional manner and a space-divisional manner, more efficient use of each bus is possible. Although a transmission side processing element and a reception side processing element are basically set at the same operation mode, when the transmission side processing element is in the synchronous operation mode, the reception side processing element can be set at the asynchronous operation mode.

In the fourth embodiment, as illustrated in FIG. 16, although the connection tables 122-1 to 122-3 and the time tables 123-1 to 123-3 are provided for each register in the register file 141, the same connection table 122 and time table 123 as in the third embodiment may be used in common by the transmission control units 144-1 to 144-3 and the reception control units 145-1 to 145-3. In such a case, however, transmission and reception by a plurality of connections can not be made at the same time from one processing element.

Entire structure of a fifth embodiment of the multiprocessor system to which the present invention is applied is the same as that shown in FIG. 1 with the only difference being that structures of a processing element and a bridge are different. In the present embodiment, similarly to the third embodiment, a local bus and a global bus each have one control channel. The biggest difference of the present embodiment from the third embodiment resides in that used as a connection number is not an arbitrary number but a number which enables a processing element as a destination to be uniquely specified.

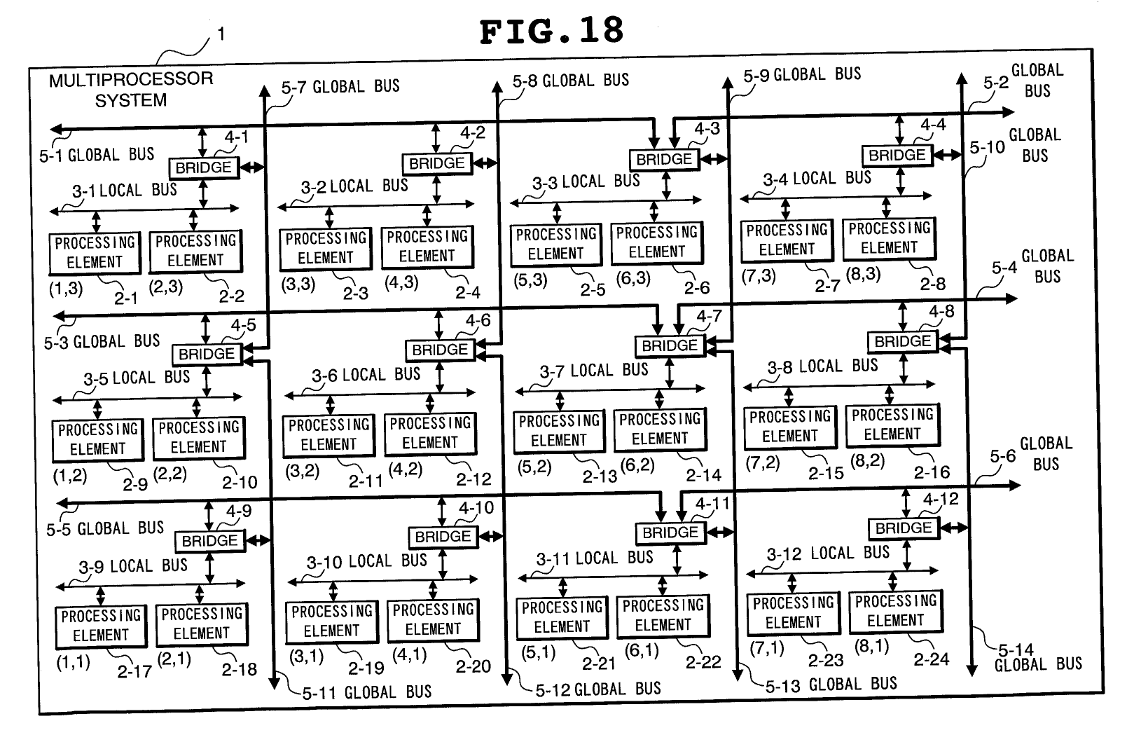

Used as a processing element number is, for example, as illustrated in FIG. 18, XY coordinate values (e.g. assume the lateral direction to be the x-axis and the vertical direction to be the y-axis) assigned to each processing element disposed in a matrix. These XY coordinate values used as connection numbers will be hereinafter referred to as “data destination”.

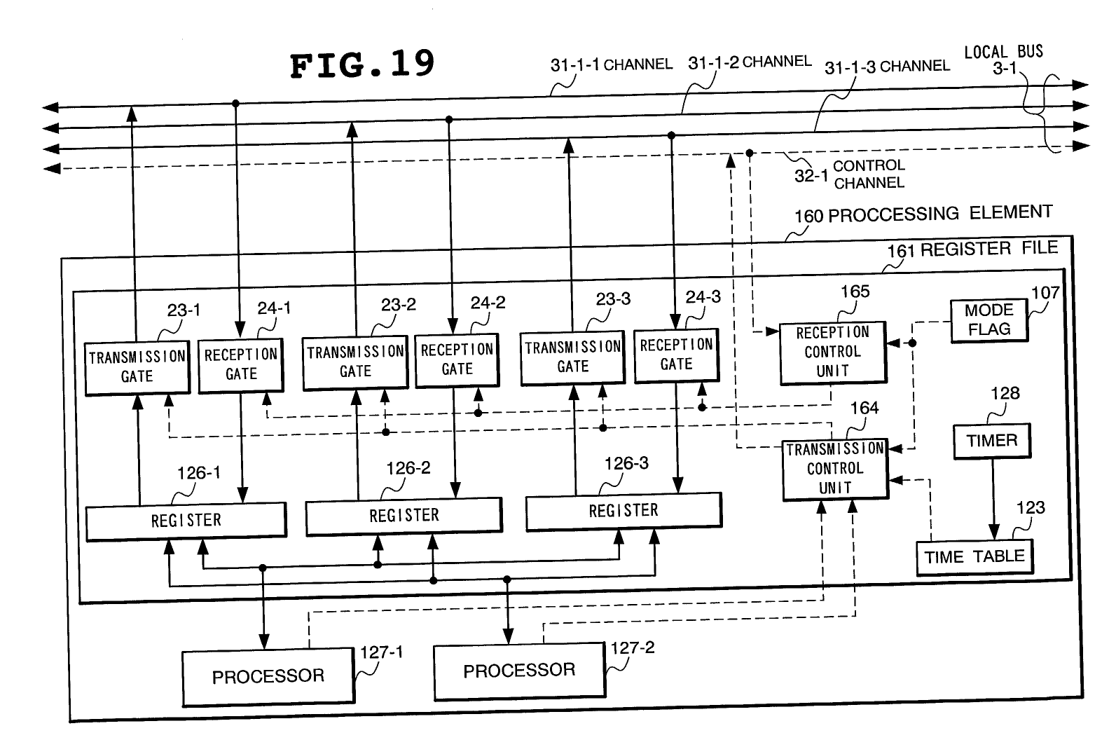

FIG. 19 shows a structure of a processing element 160 in the present embodiment. The processing element 160 has approximately the same structure as the processing element 120 of the third embodiment with the only difference being that it does not have the connection table 122. In the time table 123, data destinations are set at the position of the connections 1 to 3 in FIG. 13.

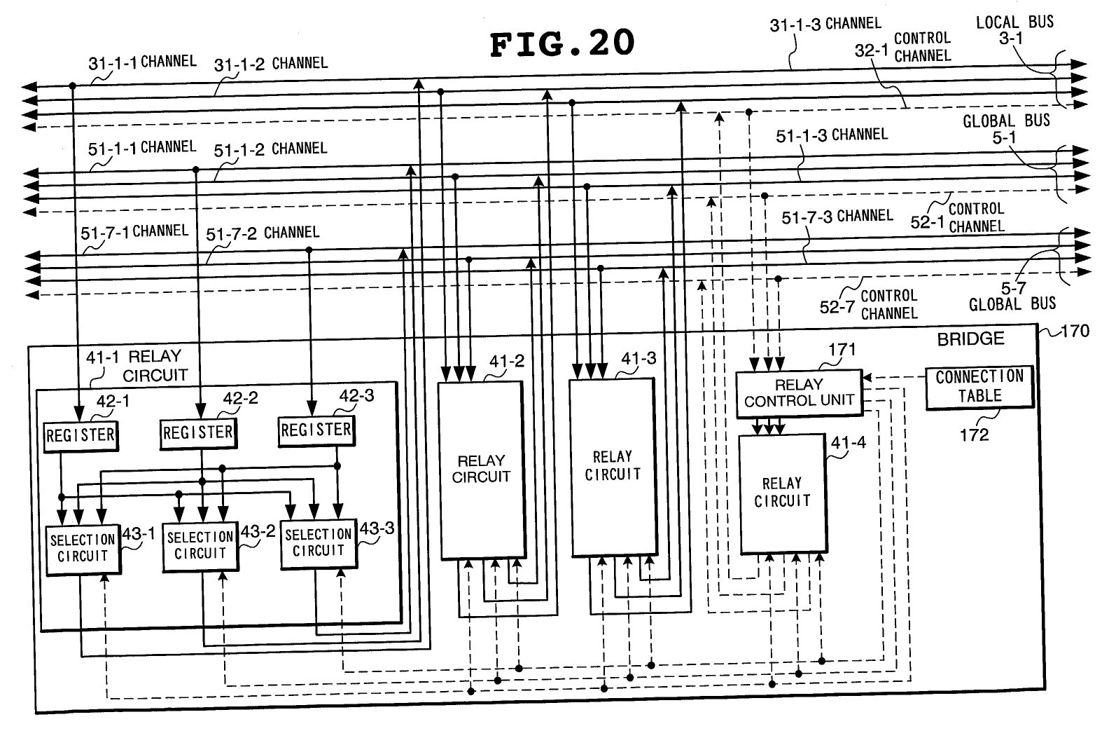

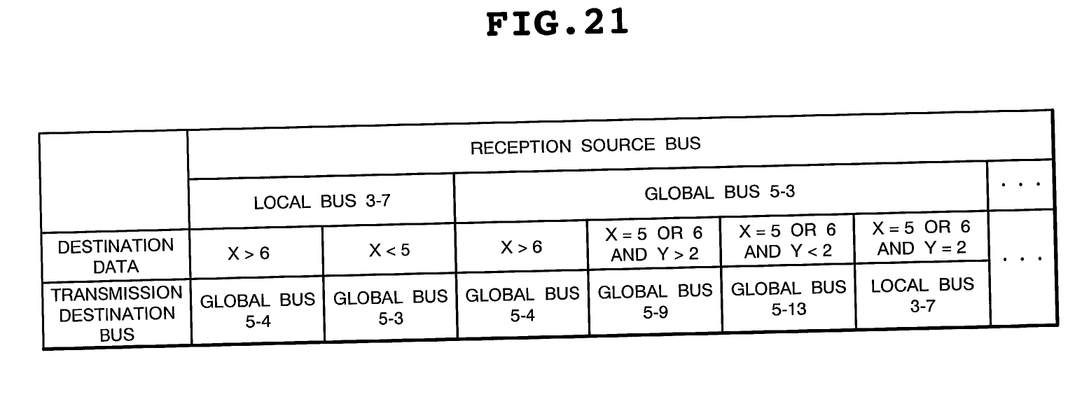

FIG. 20 shows a structure of a bridge 170 in the present embodiment. The bridge 170 has approximately the same structure as the bridge 130 according to the third embodiment with the only difference of the setting contents of a connection table 172. FIG. 21 shows an example of setting of the connection table 172 provided in the bridge 4-7.

With reference to FIG. 21, the connection table 172 in the bridge 4-7 describes, with respect to each bus, XY coordinate values of data to be received from the bus and relayed and a bus as a transmission destination of the data. The example of FIG. 21 shows an example of an X-axis preferential method of first relaying data in the X-axis direction to a position equivalent to an X coordinate of the destination of the data and then relaying the same in the Y-axis direction. For example, from each channel of the local bus 3-7, receive data having XY coordinate values of X>6 as a destination and transmit the same to the global bus 5-4, and receive data having XY coordinate values of X<5 as a destination and transmit the same to the global bus 5-3. From each channel of the global bus 5-3, receive data having XY coordinate values of X>6 as a destination and transmit the same to the global bus 5-4, receive data having XY coordinate values of X=5 or 6 and Y>2 as a destination and transmit the same to the global bus 5-9, receive data having XY coordinate values of X=5 or 6 and Y<2 as a destination and transmit the same to the global bus 5-13 and receive data having XY coordinate values of X=5 or 6 and Y=2 as a destination and transmit the same to the local bus 3-7. For the other global buses 5-4, 5-9 and 5-13, definition is also made in the same manner. In addition, for other bridges than the bridge 4-7, definition is also made in the same manner.

Next, description will be made of operation of interprocessor communication at the multiprocessor system according to the present embodiment with reference to FIGS. 18 and 21 mainly with respect to a difference from the third embodiment. Since the entire operation of the present embodiment is the same as those of the first to the third embodiments, description will be here made of operation of the processing element 160 and the bridge 170.

Also in the present embodiment, similarly to the third embodiment, the processing element 160 has two kinds of operation modes, a synchronous operation mode and an asynchronous operation mode. Description will be first made of operation of the processing element 160 in the synchronous operation mode.

Although at a transmission request from a processor, both of a register which conducts transmission and data destination are output to the transmission control unit 164, since each processor operates in synchronization with each other, the plurality of processors will not make a transmission request to the transmission control unit 164 simultaneously as long as setting is free of err. In case where the transmission requests are made simultaneously, the transmission control unit 164 is allowed to abandon the transmission requests. Then, the transmission control unit 164 informs the transmission request to a transmission gate corresponding to the register to which transmission request is made and outputs a destination of the data applied by the processor to the control channel 32-1. Upon receiving the transmission request, the transmission gate outputs the contents of the register to the local bus 3-1. In the synchronous operation mode, the time table 123 is not used in the processing element at the time of transmission control.

Next, operation of the processing element 160 in the asynchronous operation mode will be described. Also in the present embodiment as well as the third embodiment, in the asynchronous operation mode, such a transmission schedule as causes no contention is set in advance in the time tables 123 and the transmission control unit 164 conducts transmission control according to the table. In response to a transmission request applied from each processor, the transmission control unit 164 refers to the time table using a data destination to determine whether transmission is allowed or not. When a plurality of transmission requests are transmittable at the same time, select one of these transmission requests. Operation for the selected transmission request is the same as that in the synchronous operation mode. Transmission requests determined not to be transmittable and transmission requests determined to be transmittable but not selected are held in the transmission control unit 164 to set registers corresponding to the relevant transmission requests at the write-inhibited state. As time passes to make the held transmission request transmittable and selected by the transmission control unit 164, the transmission control unit 164 informs the transmission request to a transmission gate of a register corresponding to the transmission request in question and outputs the destination of data to the control channel. Then, release the transmission request in question and when all the transmission requests to the register which has made the transmission are released, release write inhibition of the register in question.

The reception control unit 165 controls switching of the reception gates 24-1 to 24-3 while monitoring the control channel 32-1. Upon receiving a destination of data from the control channel, the reception control unit 125 determines whether the destination of the data in question is its own unit or not and when the data destination is its own, informs all the reception gates that they are allowed to receive data. The reception gate monitors the local bus and when data is output on the connected channel and reception is allowed by the reception control unit 125, inputs data from the local bus to the register. In a case where the processors 127-1 and 127-2 set the register at the read-inhibited state, when data reception occurs at the register in question, the reception control unit 165 releases the read inhibition of the register in question.

When data is output on each channel of the local bus 3-1 or the global buses 5-1 and 5-7 connected, the bridge 170 takes in the data into the registers in the relay circuits 41-1 to 41-3. In addition, when a destination of the data is output on the control channel on each bus, the relay control unit 171 takes in the destination and based on the data destination and the connection table 172, determine the necessity of relay operation and a bus as a data output destination when necessary. Then, the relay control unit 171, when relay operation is necessary, informs the bus as a reception source to a selection circuit corresponding to the bus as the output destination within the relay circuits 41-4 to 41-4. Then, the relay control unit 171 transmits the data destination to the register in the relay circuit 41-4 without replacing the data destination. The selection circuit inputs data from the bus designated by the relay control unit 171 and outputs the data to the bus connected to itself.

In the present embodiment, relay operation of each bridge is controlled by such a data destination which uniquely specifies each processing element as XY coordinate values and a capacity of a connection table in each bridge can be set to be fixed irrespective of the number of connections. Although the connection table shown in FIG. 21 adopts the X-axis preferential method, it can also adopt a Y-axis preferential method of first relaying data in the Y-axis direction to a position equivalent to the Y coordinate of the data destination and then relaying the same in the X-axis direction. It is also possible to provide both a connection table using the X-axis preferential method and a connection table using the Y-axis preferential method, whereby a transmission side processor designates an identifier indicating which method is employed together with a data destination at the time of making a transmission request and propagates the identifier together with the data destination through a control channel, while each bridge uses a connection table using the method designated by the identifier.

Although the present invention has been described in the foregoing with respect to several embodiments, the present invention is not limited to the foregoing embodiments and allows other various additions and modifications.

For example, while in the fourth embodiment multiplex communication not only by a space-divisional manner but also by a time-divisional manner is allowed, multiplex communication only by space-divisional manner may be conducted without conducting time-divisional multiplex communication as other embodiment. In this case, the connection table used in the first embodiment may be provided for each channel to conduct path control on a channel basis. More specifically, with a connection table for input/output control provided for each channel in a processing element and a connection table for relay control provided for each channel in a bridge, input/output control at the processing element and path control at the bridge are determined for each channel by using these connection tables. Then, at the time of outputting data, a processor selects not less than one register to make a transmission request, a transmission control unit in the processing element refers to a connection table related to a channel corresponding to each register to which the transmission request is made to conduct output control of data from each register to a bus on a channel basis, a bridge refers to the connection table related to each channel to conduct data relay processing between buses on a channel basis and a reception control unit in the processing element refers to the connection table related to each channel to conduct input control of data from a bus to a register on a channel basis.

In addition, although in the fourth embodiment a connection table is used, it is also possible to provide a time table for each channel as in the second embodiment to conduct time-divisional and space-divisional multiplex communication. More specifically, with a time table for input/output control by time provided for each channel in a processing element and a time table for relay control by time provided for each channel in a bridge, input/output control at the processing element and path control at the bridge are determined for each channel uniquely with respect to time by using these time tables. Then, at a transmission request made by a processor, a transmission control unit in the processing element refers to each time table based on time to conduct output control of data from a register to a bus on a channel basis, the bridge refers to each time table based on time to conduct data relay processing between buses on a channel basis and a reception control unit in the processing element refers to each time table based on time to conduct input control of data from a bus to a register on a channel basis.

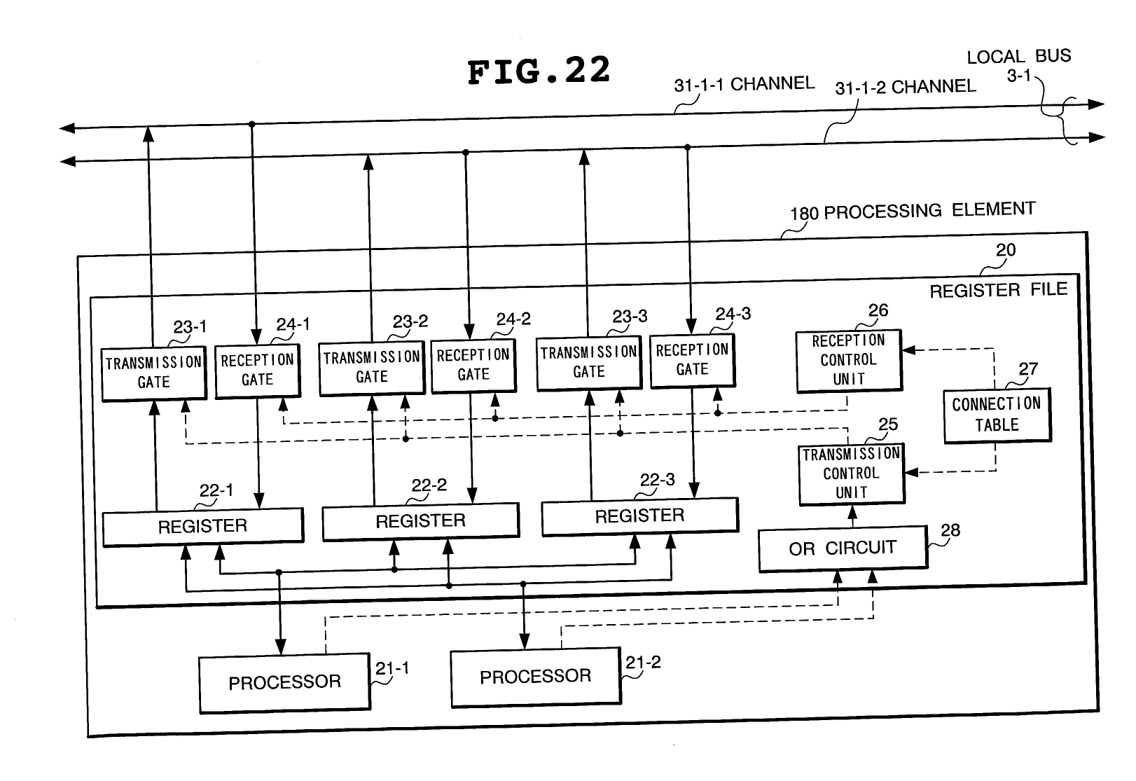

Moreover, although in the above-described respective embodiments, the number of registers in a processing element and the number of channels of a bus are the same and a register and a channel have a one-to-one correspondence, it is possible to use a bus whose number of channels is smaller than that of registers to make a plurality of registers share one channel. Example of a structure of a processing element 180 realized by adapting this concept to the first embodiment is shown in FIG. 22.

With reference to FIG. 22, the respective registers 22-1 to 22-3 in the register file 20 and the respective channels 31-1-1 and 31-1-2 in the local bus 3-1 fails to have one-to-one correspondence and a plurality of registers are connected to the same channel. More specifically, while the register 22-1 and the channel 31-1-1 have a one-to-one correspondence, the registers 22-2 and 22-3 are connected to the same channel 31-1-2. Which register will have a one-to-one correspondence to a channel and which plurality of registers will be connected to the same channel may be determined according to communication frequency of each register. Although the bridge is substantially structured as illustrated in FIG. 3 to have the same structure as that of the bridge in the first embodiment, unlike the processing element, the number of relay circuits in the bridge is smaller because channels have a one-to-one correspondence to the relay circuits 41-1 to 41-3. Since different registers use the same channel, although between registers connected to the same channel, only one register is communicable, the volume of hardware can be reduced. While FIG. 22 shows the application to the first embodiment, one channel may be shared by a plurality of registers also in other embodiment.

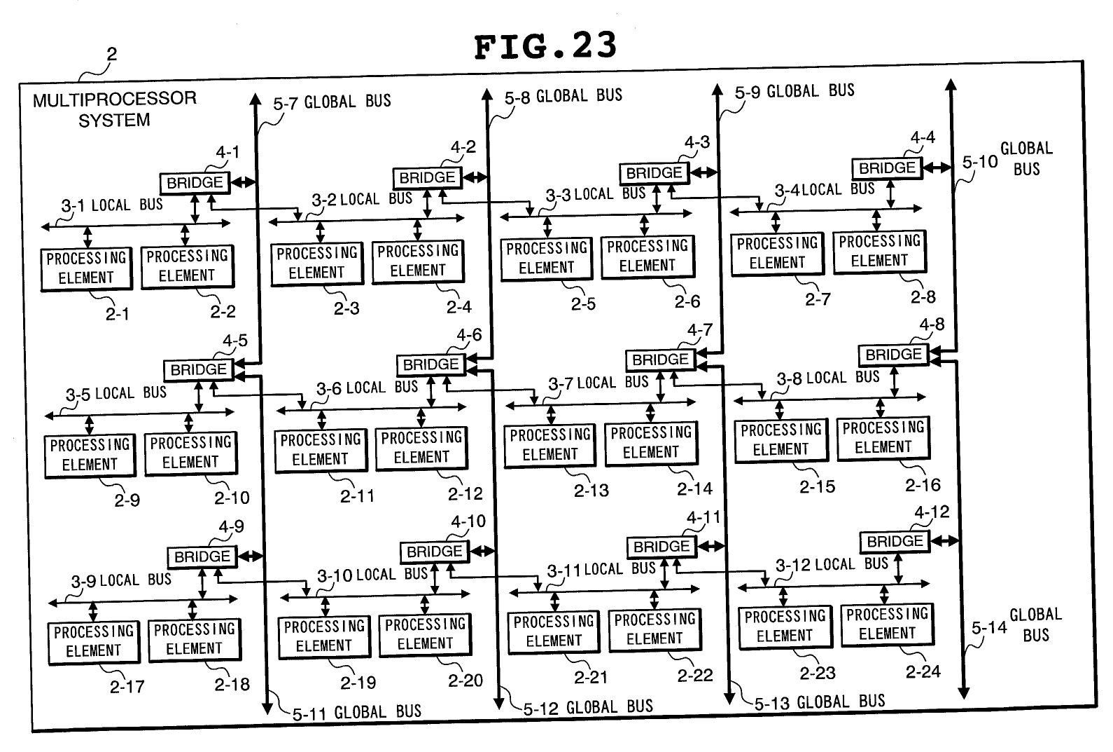

Moreover, while as a mode of connecting local buses to each other, the foregoing embodiments adopt the method shown in FIG. 1, any mode can be employed as long as a route leading from each local bus to all the remaining local buses is ensured. One example of other modes is shown in FIG. 23.

In the example shown in FIG. 23, no global bus is provided in the lateral direction and in place, a bridge serves for connecting two local buses adjacent to each other in the lateral direction. In this case, communication, for example, from the processing element 2-1 to the processing element 2-24 is conducted in the following manner. First, when data is output from the processing element 2-1 to the local bus 3-1, the bridge 4-1 relays the data to the global bus 5-7. Then, by the bridges 4-5 and 4-9, the data reaches the local bus 3-10 and by the bridges 4-10 and 4-11, the data ultimately reaches the local bus 3-12 through the local buses 3-10 and 3-11. The processing element 2-24 takes in the data output onto the local bus 3-12 into the register file. As other example, among possible modes are a mode in which with no global bus in the vertical direction, a bridge in place connects two local buses adjacent to each other in the vertical direction and a mode in which respective local buses and global buses are duplicated.

The connection mode shown in FIG. 1 has an advantage of connecting distant processing elements with a short delay. On the other hand, the connection mode shown in FIG. 23 has an advantage in circuit scale, while the amount of a delay between distant processing elements is increased as compared with that of FIG. 1 because no global bus is provided in the lateral direction.

The multiprocessor system of the present embodiment may be a multiprocessor system conducting general-purpose processing or may be a dedicated multiprocessor specialized in certain processing, for example, communication processing. In communication processing, in general, many processings including header processing, buffering processing and scheduling processing should be conducted for each cell/packet, so that an extremely high processing capacity and real-time processing are demanded. However, since communication processing, unlike general-purpose processing, has a high degree of parallelism of each processing and the processing is to some extent fixed, it is only necessary to repeat the same processing for each cell/packet. The processing in a network switch, for example, is classified into cell and packet input processing and output processing, management of various tables, routing protocol and signaling processing which are independently and in parallel executable and furthermore divided to conduct pipeline processing. Input processing, for example, can be divided from header processing to polishing/marking processing and queuing processing and between divided processings, only unidirectional reliance exists from the preceding processing to the succeeding processing, so that efficient pipeline processing can be conducted. Moreover, since communication processing is repetition of fixed processing as described above and when limiting the processing to real-time communication, each processing element can be simultaneously operated. Therefore, the above-described arbitration in contention by the synchronous operation mode which eliminates contention on a bus is enabled by determining a communication schedule in advance to produce a program.

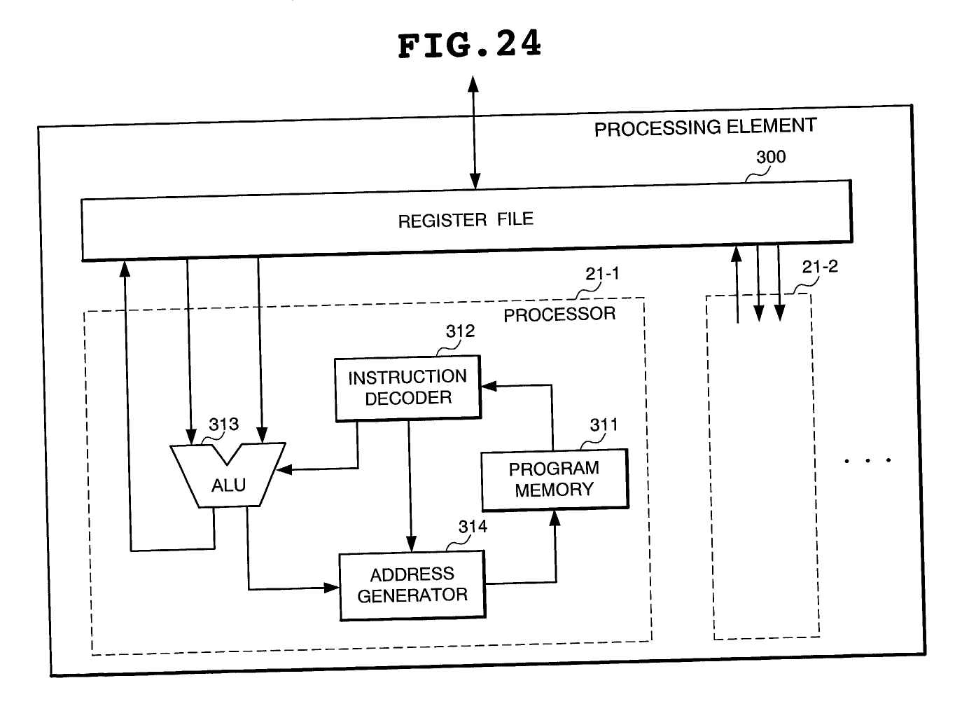

In each of the above-described embodiments, an input/output interface for receiving eternal data to be processed in the multiprocessor system and conversely, externally outputting data processed in the multiprocessor system, a memory interface for accessing such an external memory as a RAM, an internal memory, a co-processor for conducting various operations at a high speed, etc. may be provided for each processing element or provided commonly for all the processing elements or for a plurality of processing elements. In the latter case, the input/output interface, the memory interface, the internal memory, the co-processor and the like are connected, for example, to any of global buses to enable access from an arbitrary processing element. In this case, a processor in the processing element can be composed of, for example, as shown in FIG. 24, a program memory 311, an instruction decoder 312, an arithmetic and logic unit 313 and an address generator 314. Although each processor 21-1 etc. contains the memory 311 for programming, when specialized in communication processing, since the processing is small in scale and fixed, the scale of the processor can be small. When specialized in communication processing, although the arithmetic and logic unit 313 needs to have high performance in bit operation and shift operation, it may have a simplified arithmetic and logic function. The address generator 314 generates an address to be applied to the program memory 311, while the instruction decoder 312 interprets an instruction read from the program memory 311 to instruct execution of the instruction.

As described in the foregoing, the present invention attains the following effects.

Hierarchical interprocessor communication is enabled including interprocessor communication realized by sharing a register file and interprocessor communication realized by direct transfer of the contents of a register file. Therefore, making a register file be physically shared by several processors whose frequency of interprocessor communication is high enables high-speed interprocessor communication between these processors and also, direct transfer of contents of a register file through a bus enables interprocessor communication even between processors failing to physically share the register file.

As a bus connecting processing elements, use of a bus having a channel one-to-one correspondence to each register included in a register file realizes communication at a high band.

As a bus connecting processing elements, using a bus having channel whose number is smaller than that of registers included in a register file and sharing one channel by a plurality of registers reduces a bus band, while reducing the volume of hardware.

With a hierarchical bus structure made up of a plurality of buses and a bridge for relaying data between the buses, connection of several processing elements whose frequency of intercommunication therebetween is high to the same local bus enables high-speed interprocessor communication between these processing elements through one bus and also direct transfer of the contents of a register file through a plurality of local buses, bridges and global buses enables interprocessor communication even between processing elements connected to different local buses.

Determining in advance not less than one route connecting processing elements by a bus and causing no contention for a bus with other routes and making only interprocessor communication by the determined route be conducted eliminates the need of a complicated bus arbitration circuit to enable interprocessor communication with reduced hardware and reduced overhead.

Adopting the method of time-divisionally using a bus in different interprocessor communications, the method of space-divisionally using the same bus in different interprocessor communications with a bus divided into communication paths called a channel equivalent to a width of one register and a method realized by combining these methods enable higher-band interprocessor communication.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. An interprocessor communication method of exchanging the contents of register files among processors constituting a multiprocessor system, comprising the steps of:
dividing a group of processors constituting the multiprocessor system into a plurality of groups of processing elements,
conducting interprocessor communication by physically sharing the same register file among processors belonging to the same processing element, and
conducting interprocessor communication by directly transferring the contents of a register file through a bus between processors belonging to different processing elements.

2. The interprocessor communication method as set forth in claim 1, wherein
a bus is used which has a channel one-to-one corresponding to each register included in the register file.

3. The interprocessor communication method as set forth in claim 1, wherein
a bus having a channel whose number is smaller than the number of registers included in the register file is used to enable a plurality of registers to share one channel.

4. The interprocessor communication method as set forth in claim 1, wherein
a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge.

5. The interprocessor communication method as set forth in claim 1, wherein
a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge.

6. The interprocessor communication method as set forth in claim 1, wherein
a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and
not less than one route which connects the processing elements by a bus and causes no bus contention with other routes is determined in advance to conduct only interprocessor communication using the determined route.

7. The interprocessor communication method as set forth in claim 1, wherein
a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and
not less than one route which connects the processing elements by a bus and causes no bus contention with other routes is determined in advance to conduct only interprocessor communication using the determined route.

8. The interprocessor communication method as set forth in claim 1, wherein
a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and
not less than one route which connects the processing elements by a bus and causes no time contention on the same bus with other routes and a time of use of each bus by each route are determined in advance to time-divisionally use the buses, thereby conducting only interprocessor communication using said determined route and time of use.

9. The interprocessor communication method as set forth in claim 1, wherein
a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and
not less than one route which connects the processing elements by a bus and causes no time contention on the same bus with other routes and a time of use of each bus by each route are determined in advance to time-divisionally use the buses, thereby conducting only interprocessor communication using said determined route and time of use.

10. The interprocessor communication method as set forth in claim 8, wherein
the processors are operated in synchronization with time and each processor is programmed to execute only the interprocessor communication by said determined route and time of use, and each bridge conducts data relay operation only in the interprocessor communication by said determined route and time of use, thereby time-divisionally using the buses.

11. The interprocessor communication method as set forth in claim 8, wherein
a transmission control unit for controlling transmission of the contents of the register file in the processing element through the bus according to a transmission request from the processor belonging to the processing element in question provides control such that only interprocessor communication by said determined route and time of use is conducted and each bridge executes data relay operation only in interprocessor communication by said determined route and time of use, thereby time-divisionally using the buses.

12. The interprocessor communication method as set forth in claim 8, wherein
a time table for conducting input/output control by time is provided in the processing element and a time table for conducting relay control by time is provided in the bridge, and input/output control at the processing element and path control at the bridge are determined uniquely with respect to time by using these time tables, and
when a transmission request is made from the processor, a transmission control unit in the processing element refers to the time table based on time to conduct output control of data from the register to the bus, the bridge refers to the time table based on time to conduct relay processing of data between the buses and a reception control unit in the processing element refers to the time table based on time to conduct input control of data from the bus to the register, thereby
time-divisionally using the buses.

13. The interprocessor communication method as set forth in claim 8, wherein
a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data destination as control information is provided in the bus, and at the time of outputting data from the processor, a transmission request is made with the connection number or the destination as control information, a transmission control unit in the processing element refers to the connection table and the time table based on the control information to conduct output control of data and control information to the buses, the bridge refers to the connection table based on the control information received from the control channel to conduct relay processing of data and control information between the buses and a reception control unit in the processing element refers to the connection table based on the received control information to conduct input control of data from the bus to the register, thereby
time-divisionally using the buses.

14. The interprocessor communication method as set forth in claim 1, wherein
a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and
not less than one route which connects the processing elements by a bus and causes no contention on the same channel of the same bus with other routes is determined in advance to space-divisionally use the buses on a channel basis, thereby conducting only interprocessor communication using said determined route.

15. The interprocessor communication method as set forth in claim 1, wherein
a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and
not less than one route which connects the processing elements by a bus and causes no contention on the same channel of the same bus with other routes is determined in advance to space-divisionally use the buses on a channel basis, thereby conducting only interprocessor communication using said determined route.

16. The interprocessor communication method as set forth in claim 14, wherein
each processor is programmed to execute only the interprocessor communication by said determined route, and each bridge conducts data relay operation only in the interprocessor communication by said determined route, thereby
space-divisionally using the buses.

17. The interprocessor communication method as set forth in claim 14, wherein
a transmission control unit for controlling transmission of the contents of the register file in the processing element through the bus according to a transmission request from the processor belonging to the processing element in question provides control such that only interprocessor communication by said determined route is conducted and each bridge executes data relay operation only in interprocessor communication by said determined route, thereby
space-divisionally using the buses.

18. The interprocessor communication method as set forth in claim 14, wherein
a connection table for conducting input/output control is provided for each channel in the processing element and a connection table for conducting relay control is provided for each channel in the bridge, and input/output control at the processing element and path control at the bridge are determined for each channel by using these connection tables, and
at the time of outputting data from the processor, not less than one register is selected to make a transmission request, a transmission control unit in the processing element refers to the connection table related to a channel corresponding to each register to which the transmission request is made to conduct output control of data from each register to the bus on a channel basis, the bridge refers to the connection table related to each channel to conduct relay processing of data between the buses for each channel and a reception control unit in the processing element refers to the connection table related to each channel to conduct input control of data from the bus to the register for each channel, thereby
space-divisionally using the buses.

19. The interprocessor communication method as set forth in claim 1, wherein
a bus structure formed of a plurality of buses and a bridge for relaying data between the buses is used, in which a group of processing elements is divided into a plurality of groups, communication between processing elements belonging to the same group is conducted through the same one bus and communication between processing elements belonging to different groups is conducted through a plurality of buses using the bridge, and
not less than one route which connects the processing elements by a bus and causes no time contention on the same channel of the same bus with other routes and a time of use of a channel of each bus by each route are determined in advance to time-divisionally and space-divisionally use the buses on a channel basis, thereby conducting only interprocessor communication using said determined route and time of use.

20. The interprocessor communication method as set forth in claim 1, wherein
a bus structure formed of a plurality of local buses, not less than one global bus and a bridge for relaying data between the buses is used, in which a group of processing elements is divided into a plurality of groups, communication between processing elements belonging to the same group is conducted through the same one local bus and communication between processing elements belonging to different groups is conducted through a plurality of buses using the bridge, and
not less than one route which connects the processing elements by a bus and causes no time contention on the same channel of the same bus with other routes and a time of use of a channel of each bus by each route are determined in advance to time-divisionally and space-divisionally use the buses on a channel basis, thereby conducting only interprocessor communication using said determined route and time of use.

21. The interprocessor communication method as set forth in claim 19, wherein
the processors are operated in synchronization with time and each processor is programmed to execute only the interprocessor communication by said determined route and time of use, and each bridge conducts data relay operation only in the interprocessor communication by said determined route and time of use, thereby
time-divisionally and space-divisionally using the buses.

22. The interprocessor communication method as set forth in claim 19, wherein
a transmission control unit for controlling transmission of the contents of the register file in the processing element through the bus according to a transmission request from the processor belonging to the processing element in question provides control such that only interprocessor communication by said determined route and time of use is conducted and each bridge executes data relay operation only in interprocessor communication by said determined route and time of use, thereby
time-divisionally and space-divisionally using the buses.

23. The interprocessor communication method as set forth in claim 19, wherein
a time table for conducting input/output control by time is provided for each channel in the processing element and a time table for conducting relay control by time is provided for each channel in the bridge, and input/output control at the processing element and path control at the bridge are determined for each channel uniquely with respect to time by using these time tables, and
when a transmission request is made from the processor, a transmission control unit in the processing element refers to each time table based on time to conduct output control of data from the register to the bus on a channel basis, the bridge refers to each time table based on time to conduct relay processing of data between the buses on a channel basis and a reception control unit in the processing element refers to each time table based on time to conduct input control of data from the bus to the register on a channel basis, thereby
time-divisionally and space-divisionally using the buses.

24. The interprocessor communication method as set forth in claim 19, wherein
a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data designation as control information is provided for each channel in the bus, and
at the time of outputting data from the processor, a transmission request is made with the connection number or the destination as control information, a transmission control unit in the processing element refers to each connection table and each time table based on control information to conduct output control of data and control information to the buses on a channel basis, the bridge refers to each connection table based on the control information received from the control channel to conduct relay processing of data and control information between the buses on a channel basis and a reception control unit in the processing element refers to each connection table based on the received control information to conduct input control of data from the bus to the register on a channel basis, thereby
time-divisionally and space-divisionally using the buses.

25. The interprocessor communication method as set forth in claim 19, wherein
a connection table for conducting input/output control by a connection number or a data destination and a time table for conducting input/output control by time are provided in the processing element, a connection table for conducting relay control by the connection number or the data destination is provided in the bridge, and a control channel for transmitting the connection number or the data designation as control information is provided for each channel in the bus, and
at the time of outputting data from the processor, a transmission request is made with the connection number or the destination as control information, a transmission control unit in the processing element refers to the connection table and the time table based on control information to conduct output control of data and control information to the buses on a channel basis, the bridge refers to each connection table based on the control information received from the control channel to conduct relay processing of data and control information between the buses on a channel basis and a reception control unit in the processing element refers to the connection table based on the received control information to conduct input control of data from the bus to the register on a channel basis, thereby
time-divisionally and space-divisionally using the buses.

26. The interprocessor communication method as set forth in claim 12, wherein
the transmission control unit in each processing element, after a transmission request is made, inhibits write from the processor into a register relevant to the transmission request until data is actually output onto the bus.

27. The interprocessor communication method as set forth in claim 12, wherein
the contents of a register file scheduled to be received are inhibited from being read and at a time when the reception control unit inputs the data received through the bus into the register file in the processing element, are changed to be readable.

28. A multiprocessor system comprising:
a plurality of processing elements including a plurality of processors physically sharing the same register file, and
a bus structure formed of a local bus for connecting register files of several adjacent processing elements with each other, not less than one global bus for connecting the local buses and not less than one bridge for relaying data between the buses.

29. The multiprocessor as set forth in claim 28, wherein
each said bus has a channel one-to-one corresponding to each register included in the register file.

30. The multiprocessor as set forth in claim 28, wherein
each said bus has a channel whose number is smaller than the number of the registers included in the register file.

31. The multiprocessor as set forth in claim 28, wherein
each said bus has a channel one-to-one corresponding to each register included in the register file,
the register file of each processing element includes a time table for conducting input/output control by time, a transmission control unit for, when a transmission request is made from the processor, referring to the time table based on time to control output of data from the register to the bus and a reception control unit for referring to the time table based on time to control input of data from the bus to the register, and
each bridge includes a time table for conducting relay control by time and a relay circuit for referring to the time table based on time to conduct relay processing of data between the buses, thereby
forming a structure time-divisionally using buses.

32. The multiprocessor as set forth in claim 28, wherein
each said bus has a channel whose number is smaller than the number of the registers included in the register file,
the register file of each processing element includes a time table for conducting input/output control by time, a transmission control unit for, when a transmission request is made from the processor, referring to the time table based on time to control output of data from the register to the bus and a reception control unit for referring to the time table based on time to control input of data from the bus to the register, and
each bridge includes a time table for conducting relay control by time and a relay circuit for referring to the time table based on time to conduct relay processing of data between the buses, thereby
forming a structure time-divisionally using buses.

33. The multiprocessor as set forth in claim 28, wherein
each said bus has a channel one-to-one corresponding to each register included in the register file,
each bus includes a control channel for transmitting a connection number or a destination of data as control information,
the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses, and a reception control unit for referring to the connection table based on control information received from the bus to control input of data from the bus to the register, and
each bridge includes a connection table for conducting relay control by the connection number or the data destination, and a relay control unit and a relay circuit for referring to the connection table based on control information received from the control channel to conduct relay processing of data and control information between the buses, thereby
forming a structure time-divisionally using buses.

34. The multiprocessor as set forth in claim 28, wherein
each said bus has a channel whose number is smaller than the number of the registers included in the register file,
each bus includes a control channel for transmitting a connection number or a destination of data as control information,
the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses, and a reception control unit for referring to the connection table based on control information received from the bus to control input of data from the bus to the register, and
each bridge includes a connection table for conducting relay control by the connection number or the data destination, and a relay control unit and a relay circuit for referring to the connection table based on control information received from the control channel to conduct relay processing of data and control information between the buses, thereby
forming a structure time-divisionally using buses.

35. The multiprocessor as set forth in claim 28, wherein
each said bus has a channel one-to-one corresponding to each register included in the register file, and
the register file of each processing element includes a connection table for each channel for conducting input/output control, a transmission control unit for, when a transmission request designating a register which conducts transmission is made from the processor, referring to the connection table related to a channel corresponding to each register to which the transmission request is made to control output of data from each register to the bus on a channel basis, and a reception control unit for referring to the connection table related to each channel to control input of data from the bus to the register on a channel basis, and
each bridge includes a connection table for each channel for conducting relay control and a relay circuit for referring to the connection table related to each channel to conduct relay processing of data between the buses, thereby
forming a structure space-divisionally using buses.

36. The multiprocessor as set forth in claim 28, wherein
each said bus has a channel whose number is smaller than the number of the registers included in the register file, and
the register file of each processing element includes a connection table for each channel for conducting input/output control, a transmission control unit for, when a transmission request designating a register which conducts transmission is made from the processor, referring to the connection table related to a channel corresponding to each register to which the transmission request is made to control output of data from each register to the bus on a channel basis, and a reception control unit for referring to the connection table related to each channel to control input of data from the bus to the register on a channel basis, and
each bridge includes a connection table for each channel for conducting relay control and a relay circuit for referring to the connection table related to each channel to conduct relay processing of data between the buses, thereby
forming a structure space-divisionally using buses.

37. The multiprocessor as set forth in claim 28, wherein
each said bus has a channel one-to-one corresponding to each register included in the register file,
the register file of each processing element includes a time table for each channel for conducting input/output control by time, a transmission control unit for, when a transmission request is made from the processor, referring to each time table based on time to control output of data from the register to the bus on a channel basis, and a reception control unit for referring to each time table based on time to control input of data from the bus to the register on a channel basis, and
each bridge includes a time table for each channel for conducting relay control by time and a relay circuit for referring to each time table based on time to conduct relay processing of data between the buses on a channel basis, thereby
forming a structure time-divisionally and space-divisionally using buses.

38. The multiprocessor as set forth in claim 28, wherein
each said bus has a channel whose number is smaller than the number of the registers included in the register file,
the register file of each processing element includes a time table for each channel for conducting input/output control by time, a transmission control unit for, when a transmission request is made from the processor, referring to each time table based on time to control output of data from the register to the bus on a channel basis and a reception control unit for referring to each time table based on time to control input of data from the bus to the register on a channel basis, and
each bridge includes a time table for each channel for conducting relay control by time and a relay circuit for referring to each time table based on time to conduct relay processing of data between the buses on a channel basis, thereby
forming a structure time-divisionally and space-divisionally using buses.

39. The multiprocessor as set forth in claim 28, wherein
each said bus has a channel one-to-one corresponding to each register included in the register file,
each bus includes a control channel for each channel for transmitting a connection number or a destination of data as control information,
the register file of each processing element includes a connection table for each channel for conducting input/output control by the connection number or the destination of data and a time table for each channel for conducting input/output control by time, a transmission control unit for, when a transmission request with the connection number or the destination as control information is made from the processor, referring to each connection table and each time table based on the control information to control output of the data and the control information to the bus on a channel basis, and a reception control unit for referring to each connection table based on control information received from the bus to control input of data from the bus to the register on a channel basis, and
each bridge includes a connection table for each channel for conducting relay control by the connection number or the data destination, and a relay control unit and a relay circuit for referring to each connection table based on control information received from the control channel to conduct relay processing of data and the control information between the buses on a channel basis, thereby
forming a structure time-divisionally and space-divisionally using buses.

40. The multiprocessor as set forth in claim 28, wherein
each said bus has a channel whose number is smaller than the number of the registers included in the register file,
each bus includes a control channel for each channel for transmitting a connection number or a destination of data as control information,
the register file of each processing element includes a connection table for each channel for conducting input/output control by the connection number or the destination of data and a time table for each channel for conducting input/output control by time, a transmission control unit, for when a transmission request with the connection number or the destination as control information is made from the processor, referring to each connection table and each time table based on the control information to control output of the data and the control information to the bus on a channel basis, and a reception control unit for referring to each connection table based on control information received from the bus to control input of data from the bus to the register on a channel basis, and
each bridge includes a connection table for each channel for conducting relay control by the connection number or the data destination, and a relay control unit and a relay circuit for referring to each connection table based on control information received from the control channel to conduct relay processing of data and the control information between the buses on a channel basis, thereby
forming a structure time-divisionally and space-divisionally using buses.

41. The multiprocessor as set forth in claim 28, wherein
each said bus has a channel one-to-one corresponding to each register included in the register file,
each bus includes a control channel for each channel for transmitting a connection number or a destination of data as control information,
the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses on a channel basis, and a reception control unit for referring to the connection table based on control information received from the bus to control input of data from the bus to the register on a channel basis, and
each bridge includes a connection table for each channel for conducting relay control by the connection number or the data destination, and a relay control unit and a relay circuit for referring to each connection table based on control information received from the control channel to conduct relay processing of the data and the control information between the buses on a channel basis, thereby
forming a structure time-divisionally and space-divisionally using buses.

42. The multiprocessor as set forth in claim 28, wherein
each said bus has a channel whose number is smaller than the number of the registers included in the register file,
each bus includes a control channel for each channel for transmitting a connection number or a destination of data as control information,
the register file of each processing element includes a connection table for conducting input/output control by the connection number or the data destination and a time table for conducting input/output control by time, a transmission control unit for, when a transmission request is made from the processor using the connection number or the destination as control information, referring to the connection table and the time table based on the control information to control output of data and control information to the buses on a channel basis, and a reception control unit for referring to the connection table based on control information received from the bus to control input of data from the bus to the register on a channel basis, and
each bridge includes a connection table for each channel for conducting relay control by the connection number or the data destination, and a relay control unit and a relay circuit for referring to each connection table based on control information received from the control channel to conduct relay processing of the data and the control information between the buses on a channel basis, thereby
forming a structure time-divisionally and space-divisionally using buses.

43. The multiprocessor as set forth in claim 31, wherein
the transmission control unit in each processing element has a structure of inhibiting, after a transmission request is made, write from a processor into a register relevant to the transmission request until data is actually output onto the bus.

44. The multiprocessor as set forth in claim 32, wherein
the transmission control unit in each processing element has a structure of inhibiting, after a transmission request is made, write from the processor into a register relevant to the transmission request until data is actually output onto the bus.

45. The multiprocessor as set forth in claim 31, including
a structure of inhibiting read of the contents of a register file scheduled to be received and changing the contents to be readable at a time when the reception control unit inputs the data received through the bus into the register file in the processing element.

46. The multiprocessor as set forth in claim 32, including
a structure of inhibiting read of the contents of a register file scheduled to be received and changing the contents to be readable at a time when the reception control unit inputs the data received through the bus into the register file in the processing element.
